(19) United States
(12) Patent Application Publication
(10) Pub. No.: US 2026/0109143 A1
(43) Pub. Date: Apr. 23, 2026

(54) COATING DEVICE FOR COATING A CARRIER SUBSTRATE WITH A DRY FILM

(71) Applicant: KOENIG & BAUER AG, Würzburg (DE)

(72) Inventor: Jann NEUMANN, Waldbüttelbrunn (DE)

(21) Appl. No.: 19/146,584

(22) PCT Filed: Aug. 17, 2023
(86) PCT No.: PCT/EP2023/072668

§ 371 Date: Jul. 9, 2025

(30) Foreign Application Priority Data
Jan. 12, 2023 (DE) 10 2023 100 612.6

(51) Int. Cl. B32B 37/24; H01M 4/04

(52) U.S. Cl. CPC B32B 37/24; H01M 4/0404; H01M 4/0435; B32B 2457/10

(57) ABSTRACT

Examples include a coating device including an application unit by which powdered material is applied to a side of a carrier substrate. The application unit includes a first roller and a second roller that form a gap into which the powdered material can be fed via a dispensing device. The dispensing device includes a receptacle which is caused to vibrate by a vibratory drive. An opening of the receptacle is adjoined by a feed channel via which the powdered material is dispensed from the receptacle into a chamber located therebeneath. A supply reservoir supplies the powdered material to the receptacle. The outlet of the supply reservoir is arranged spaced apart from the opening of the receptacle, and the feed channel is immersed with an outlet into the chamber, which is formed over the gap in the wedge-shaped space between the outer cylindrical surfaces of the first and second rollers.

### CROSS-REFERENCES TO RELATED APPLICATIONS

This application is the US national phase, under 35 USC § 371, of PCT/EP2023/072668, filed on Aug. 17, 2023, published as WO 2024/149474 A1 on Jul. 18, 2024, and claiming priority to DE 10 2023 100 612.6 filed on Jan. 12, 2023, and all of which are incorporated by reference herein in their entireties.

### TECHNICAL FIELD

Some examples herein relate to a coating device for coating a carrier substrate with a dry film. The coating device includes at least one application unit by which powdered material can first be processed to a dry film using a compression force, and thereafter this dry film can be applied to a first side of the carrier substrate as a powder composite film. The application unit further comprises a powder feed device for feeding a powdered material and a first roller and a second roller forming a first roller gap with the first roller, a filling and/or supply chamber, into which powdered material can be fed via a dispensing device comprised by the powder feed device, being formed and/or provided in the region of the wedge-shaped space formed above the gap between the outer cylindrical surfaces of the first and second rollers, the second roller or a roller which cooperates with the second roller directly or indirectly via one or more further rollers and is effective as a laminating roller, in the nip between the outer cylindrical surface thereof and the outer cylindrical surface of a roller effective as a counter-pressure roller, forming a second roller gap through which the carrier substrate can be guided and have the second dry film formed via the first roller gap applied thereto.

### BACKGROUND

A device and a method for coating a carrier substrate are known from DE 10 2017 208 220 A1, wherein a dry film is formed in a gap between a first and a second roller and, in one embodiment, is transferred in a gap by way of a further roller to the carrier substrate. The rollers are operated at a differential speed for forming fibrils.

US 2015/0224529 A1 discloses a device for coating an object to be coated with coating material, wherein the coating material contains, amongst others, 20 to 65 volume % water. The layer is formed between a first and a second roll, wherein the first roll has improved transfer properties for enhanced transfer, for example, a rougher surface, and the rolls can be operated at differing velocities. Two different concepts for the coating process are disclosed here. In the first design, a film is produced in the roller gap between the first and second rollers from powder that is fed to the roller gap and, at the same time, a web that is passed through this gap is coated with this film. In a second design, a film is first formed from powder in the gap between the first and second roller, this film is conveyed over the second roller and, in a further gap between the second roller and a further roller, is applied to a web that is formed by this further gap.

In WO 2020/150254 A1, a film is generated by calendering a powder mixture and is wound onto a reel so as to be supplied as such to a further process in which it can be laminated onto a collector. In one embodiment, the powder mixture is deposited onto a belt and is guided thereon into the roller nip of two rollers.

JP 57 72 427 B2 relates to a powder rolling device for producing an electrode material from powder. In one embodiment, powder is conveyed by a central vibrating conveyor into a central region of a supply hopper and by two outer vibrating conveyors into the edge regions. In another embodiment, the feeding hopper has five sections.

WO 01/32312 A1 discloses a roller mill for grinding granular materials, in particular cereals, comprising a feed device having an opening, by which the grains can be transferred into a grinder formed by two rollers. The feed device comprises a vibratory drive for generating a vibratory motion of the feed device.

JP 5772427 B2 relates to the production of a film by pressing a powder in the roller gap between two rollers. The powder is fed to the roller gap via a hopper that is formed over the roller gap. The hopper receives the powder from a feed opening at the downstream end of a vibrating conveyor, which in turn receives the powder from a loading hopper. A layer thickness is set or adjusted by varying the vertical position of the feed opening and thus the height of the powder column over the roller gap.

A feeding mechanism for a roller system for producing battery electrodes is disclosed by CN 216749956 U, wherein a weighing device is provided at the inlet of the feed system for setting the raw material quantities for the powder mixture. The materials are mixed in a receptacle, fed to a heating container, and from there via a vibrating conveyor to a hopper-like receptacle provided above the wedge-shaped roller space.

CN 215964437 U and CN 113102160 A relate to a device for feeding a high-viscosity battery slurry and to a coating device, wherein the slurry is first conveyed by a screw conveyor to a feeding hopper, which comprises at least one vibrating output unit, and from there is applied to the collector foil. In one embodiment of CN 215964437 U, the slurry is first applied and, downstream, is guided between two rollers, and in another embodiment of CN 215964437 U as well as in CN 113102 160 A, the collector foil is guided from above through a roller gap between two rollers, while applying the slurry thereto from the upper wedge-shaped space.

JP S49-32 930 A discloses a device for uniformly dispersing and coating powder, wherein the powder, assisted by a vibrator, drops out of a hopper through a sieve onto a roller, from where it is guided via a roller train made up of rollers having the same direction of rotation to a roller gap, in which a web that is guided through is coated with the powder.

A device for producing cathode collectors is disclosed by US 2007/0143989 A1, wherein a collector substrate web is guided through a roller gap and coated with a powder layer on both sides. The powder is fed on both sides of the web leaving the roller gap from a vibration conveyor via a respective material chute into a supply reservoir located over the roller gap.

### SUMMARY

It is an object of some examples herein to provide a coating device for coating a carrier substrate with a dry film.

The object discussed above is achieved in some examples by the coating device discussed above that includes the dispensing device and in which the dispensing device includes a receptacle which is to be caused to vibrate by a vibratory drive and further has a bottom. An opening is provided in the bottom of the receptacle and is adjoined on the output side by a feed channel via which the powdered material can be dispensed from the receptacle into the filling and/or supply chamber located therebeneath. A supply reservoir includes an outlet, via which the receptacle that is caused to vibrate is or can be supplied with powdered material, the outlet of the supply reservoir being arranged spaced apart from the opening, viewed in the horizontal direction. Further, the feed channel on the output side is immersed with an outlet into the filling and/or supply chamber formed over the roller gap in the wedge-shaped space between the outer cylindrical surfaces of the first roller and the second roller.

The advantages achievable by the invention are in particular that a coated carrier substrate, comprising an active material layer that is as even as possible and/or subject to few defects, can be continuously and reliably produced by means of the application unit and/or the coating device.

By feeding the material by way of a jogging receptacle having a significantly high filling height of the material to be fed into the filling and/or supply chamber holding the powdered material, it is possible to achieve feeding into a film-forming gap which does not vary or varies only little in terms of the width, and thereby the formation of a uniform layer.

In an embodiment of an application unit comprising a powder feed device for feeding a powdered material, which is particularly suitable for the invention, in which the application unit comprises a first roller and a second roller forming a gap with the first roller, a filling and/or supply chamber having a width that extends in the axial direction of the second roller, into which powdered material can be fed directly or indirectly via a metering device comprised by the powder feed device, is formed and/or provided in the region of the so-called wedge-shaped space above the gap, that is, in the space that is formed over the gap between the outer cylindrical surfaces of the two rollers and that in particular has a wedge-like or triangle-like profile. According to the invention, the dispensing device comprises a receptacle, which is to be caused to vibrate by a vibratory drive and has a bottom and a, for example, circumferential wall, wherein the powdered material can be dispensed downstream via at least one opening provided in the bottom of the receptacle into the filling and/or supply chamber, wherein an outlet of the feed channel on the output side is immersed into the filling and/or supply chamber formed over the roller gap between the outer cylindrical surfaces of the first roller and the second roller in the wedge-shaped space. As is also apparent from the figures, the space between the rollers described as being wedge-like or triangle-like and also referred to as a wedge-shaped space is a space that has a substantially triangular or wedge-shaped profile, which is delimited on two sides by two concavely inwardly curved lines or surfaces, that is, the cylindrical roller surfaces, and at the top by an imaginary tangent or tangential plane bearing against the rollers.

In a particularly advantageous embodiment, a fill level sensor is provided above the bottom that has the opening, in particular over the opening. The fill level sensor is preferably arranged so as to be able to monitor the fill level in the receptacle and/or in or over the feed channel.

In a refinement, viewed in the direction of the roller gap, multiple openings are provided next to one another and/or a channel, which at the downstream and/or lower end has an outlet that is immersed into the filling and/or supply chamber, adjoins the only or respective opening.

A coating device for dry coating a carrier substrate with a dry film, in particular a powder composite film, which is to be particularly preferred, comprises at least one application unit in an above-described embodiment, by which powdered material can first be processed to a dry film by applying a compression force, and thereafter this dry film can be applied to a first side of the carrier substrate, in particular by way of pressing and/or using a contact pressure force, as a powder composite film.

The second roller or a roller that cooperates with the second roller directly or indirectly via one or more further rollers and is effective as the laminating roller, in the nip between the outer cylindrical surface thereof and the outer cylindrical surface of a roller that is effective as a counter-pressure roller, forms a second roller gap, through which the carrier substrate (006) can be guided and can have the dry film formed by way of the first roller gap applied thereto.

In an advantageous embodiment, the coating device comprises a second application unit in the above embodiment, in which powdered material can be introduced via a further powder feed device and be processed therein to a second dry film, and subsequently this second dry film can be applied to the other, second side of the carrier substrate, wherein a first roller and a second roller are likewise provided in the second application unit in such a way that the second rollers of the two application units together form the second roller gap, through which the carrier substrate can be guided and have the dry film that is formed by way of the respective first gap applied to both sides simultaneously.

### BRIEF DESCRIPTION OF THE DRAWINGS

Exemplary embodiments of the invention are illustrated in the drawings and will be described in greater detail below. The figures show:

FIG. 1 a schematic representation of a product to be produced;

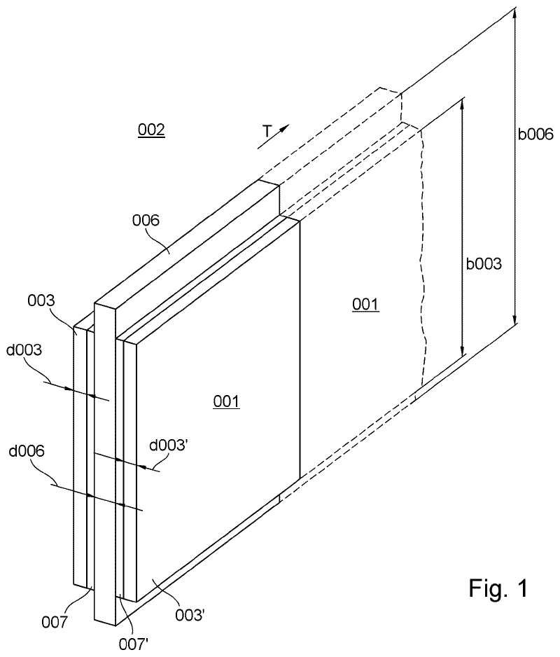

FIG. 2 a schematic diagram for the generation and the application of a dry film;

FIG. 3 an exemplary embodiment of a machine for producing a multi-layer product including a dry film that is applied to a carrier substrate with an application stage according to one embodiment of a first group of exemplary embodiments;

FIG. 4 an enlarged view of the application stage of the first embodiment from FIG. 3;

FIG. 5 an alternative embodiment of one embodiment of the first group of exemplary embodiments;

FIG. 6 a further alternative embodiment of the embodiment of a first group of exemplary embodiments;

FIG. 7 a further alternative embodiment of the embodiment of a first group of exemplary embodiments;

FIG. 8 a schematic diagram of one embodiment of a second group of exemplary embodiments;

FIG. 9 a schematic diagram of a further embodiment of a second group of exemplary embodiments;

FIG. 10 an exemplary embodiment of a machine for producing a multi-layer product including a dry film that is applied to a carrier substrate with an application stage according to one embodiment of the second group of exemplary embodiments;

FIG. 11 an enlarged view of the application stage from FIG. 10 with the coupling of two rollers in pairs in a first design;

FIG. 12 an enlarged view of the application stage from FIG. 10 with the coupling of two rollers in pairs in a second design;

FIG. 13 a representation obliquely from beneath with removal devices;

FIG. 14 an oblique view of a product section a slight lateral primer protrusion;

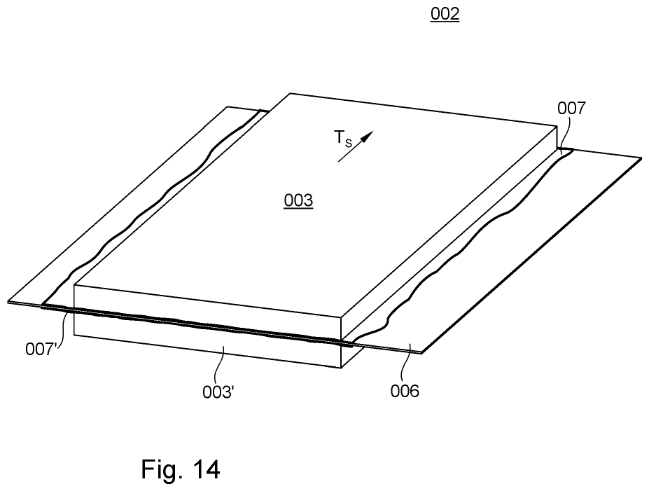

FIG. 15 another exemplary embodiment of a machine for producing a multi-layer product including a dry film that is applied to a carrier substrate with an application stage according to one embodiment of the second group of exemplary embodiments;

FIG. 16 another exemplary embodiment of a machine for producing a multi-layer product including a dry film that is applied to a carrier substrate with an application stage according to one embodiment of the second group of exemplary embodiments;

FIG. 17 a schematically represented application unit with a first embodiment of a device for feeding powdered material into the roller gap;

FIG. 18 a schematically represented application unit comprising a sensor system provided in the drop path in a first embodiment;

FIG. 19 a schematically represented application unit comprising a sensor system provided in the drop path in a second embodiment;

FIG. 20 a) a schematically represented application unit with a further advantageous embodiment for the device for feeding powdered material into the roller gap in an oblique view and b) in a detailed view from a);

FIG. 21 a schematic sectional view of an application unit with a further advantageous embodiment for the device for feeding powdered material into the roller gap;

FIG. 22 an application unit schematically represented in an oblique view with a further advantageous embodiment for the device for feeding powdered material into the roller gap;

FIG. 23 an application unit schematically represented in an oblique view with a further advantageous embodiment for the device for feeding powdered material into the roller gap;

FIG. 24 a schematically represented application unit with a further advantageous embodiment for the device for feeding powdered material into the roller gap a) in a side view and b) from above; and

FIG. 25 a schematic representation of one exemplary embodiment of a device for determining the density of a material layer conveyed on an outer cylindrical surface of a roller.

### DETAILED DESCRIPTION

The devices or machines described hereafter relate to the production of electrode units 001 of electrochemical storage systems as they are used, in particular, in batteries or rechargeable batteries, such as lithium-sulfur, sodium-ion or in particular lithium-ion batteries, as well as in solid-state batteries.

A product 001; 002 to be produced by a machine described below can, for example, be formed by a, for example web-format, intermediate product 002 that is still to be cut, for example a product strand 002 designed as an electrode strand 002, or by sheet-format end products 001 that have already been cut in the machine, for example as product sections 001 formed as electrode units 001, electrodes 001 for short.

For producing such products 001; 002 having a material layer 003; 003′, in particular active material layer 003; 003′, which is applied to one side or both sides of a carrier substrate 006, preferably a carrier substrate web 006, for example a current collector substrate 006 formed by, for example, a current collector foil 006, preferably applied in the form of a dry film 003; 003′, a device 100; 100* for coating, coating device 100; 100* for short, in particular for dry coating an, in particular web-format, for example above-described, carrier substrate 006 with an above-described material layer 003; 003′, preferably a dry film 003; 003′, in particular a powder composite film 003, is provided, which comprises at least one first application unit 101, by which powdered, preferably dry, material 004; 004′, in particular a preferably solvent-free and/or dry powder mixture 004; 004′, can first be processed to a dry film 003, in particular by way of compression and/or using a compression force, and thereafter this dry film 003; 003′ can be applied to a first side of the carrier substrate 006, in particular by way of pressing and/or using a contact pressure force. A dry film 003; 003′ to be applied is to have, for example, a thickness of 20 μm to 240 μm, preferably of 40 μm to 100 μm, for example after the application and compression.

An above-described powder mixture 004; 004′, which is in particular present as dry powder, comprises, in particular for the production of electrode units 001 for lithium-ion batteries or rechargeable batteries, for example more than ninety percent by weight of an active material, such as one or more of the lithium compounds: lithium iron phosphate, lithium manganese oxide, nickel-rich lithium nickel manganese cobalt oxide, lithium nickel cobalt aluminum oxide, lithium cobalt oxide, lithium manganese nickel oxide and/or lithium titanate, few, for example three, percent by weight of a conductive additive, for example graphite or so-called CNTs, that is, multi-walled carbon nanotubes, and few, for example two, percent by weight of a plastic that is effective as binding agent in the later powder composite, for example polytetrafluoroethylene (PTFE).

The carrier substrate 006 at the same time, for example, represents the current-collecting layer of the electrode unit 001 and is formed, for example, by electrically conductive material, for example a metal, designed in the form of a film, non-woven fabric or woven fabric. It is made, for example, of aluminum or copper, in particular for the production of electrode units 001 for lithium-ion batteries or rechargeable batteries, and/or, for example, has a thickness d006 of 5 to 16 μm. If an anode is produced, it is made in particular of copper having, for example, a thickness d006, for example, in the range of 5 to 13 μm, and if a cathode is produced, it is made in particular of aluminum having, for example, a thickness d006 in the range of 7 to 16 μm.

In a preferred embodiment, the carrier substrate 006, at least in the surface region to be coated with the dry film 003; 003′, has a superficial coating with a cohesion-supporting or cohesion-inducing agent 007; 007′, for example a binder 007; 007′, a primer 007; 007′ or an adhesive 007; 007′. Such an agent 007; 007′can be formed by a thermoplastic or reactive binder or primer and can, for example, comprise a thermoplastic component and/or have a thickness d007 of only few μm, for example no more than 5 μm, in particular no more than 3 μm.

A thickness d003; d003′ of the active material layer 003; 003′ of the product 001; 002, that is, of the electrode unit 001 or of the electrode strand 002, is, for example, no more than 240 μm, in particular no more than 150 Ξm, preferably at most 100 μm, and/or is, for example, at least 20 μm, in particular at least 30 μm, preferably at least 40 μm.

An overall thickness of the product 001; 002 coated, for example, on both sides, is, for example, up to 500 μm, in particular up to 320 μm, preferably up to 220 μm and/or at least 50 μm, in particular at least 70 μm, preferably at least 90 μm.

To ensure an effective manufacturing process, preferably web-format carrier material 006 is processed to an above-described end or intermediate product which, for example, has a width of at least 500 mm, in particular at least 600 mm, in a particularly advantageous embodiment even at least 1,200 mm. The carrier material 006 is, for example, not coated over the entire width with the dry film 003; 003′, but only up to an omitted edge region in which the surface of the metallic conducting carrier material 006 remains free and accessible, for example for the purpose of being connected to cables.

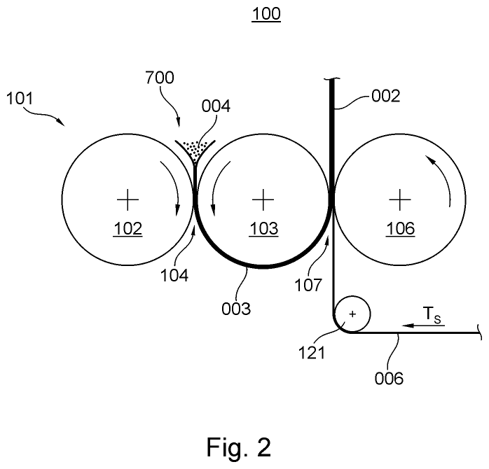

For the above-described production of a dry film 003, a first roller 102, in particular a metering roller 102, and a second roller 103, in particular a laminating roller 103 of the first application unit 101, are provided so as to form, in the nip between the outer cylindrical surfaces thereof, a first gap 104, in particular a first film-forming gap 104, through which, for the purpose of forming the dry film 003, the powder mixture 004 which is conveyed into the nip, for example by a device for feeding powdered material 700, a powder feed device 700 for short, can be conveyed (see, for example, FIG. 2). An inside width of the first gap 104 at the narrowest point thereof determines the thickness of the dry film 003, which may still be larger compared to the thickness in the later product 001; 002, even before the same passes an application point at which it is applied, in particular under pressure, to the carrier substrate 006.

The application point here is preferably formed directly by a nip of the second roller 103, which in this case is effective as a laminating roller 103, with a roller 106; 103 that is effective as a counter-pressure roller 106; 103′ or by a roller which cooperates with the second roller directly or indirectly via one or more further rollers and which is effective as a laminating roller, with a roller 106; 103 that is effective as a counter-pressure roller 106; 103′ (not shown here). The second or further roller effective as the laminating roller 003 and the roller 106; 103 effective as the counter-pressure roller 106; 103 form, in the nip between the outer cylindrical surfaces thereof, a second gap 107, in particular an application gap 107, hereafter also, for example, referred to as a laminating gap 107, through which the carrier substrate 006 can be guided, to which, in particular from the side facing away from the counter-pressure roller 106; 103, the dry film 003 which is formed via the first film-forming gap 104 and, for example, is at least 40 μm thick, for example between 50 μm and 200 μm, in particular 60 to 120 μm thick, can be applied.

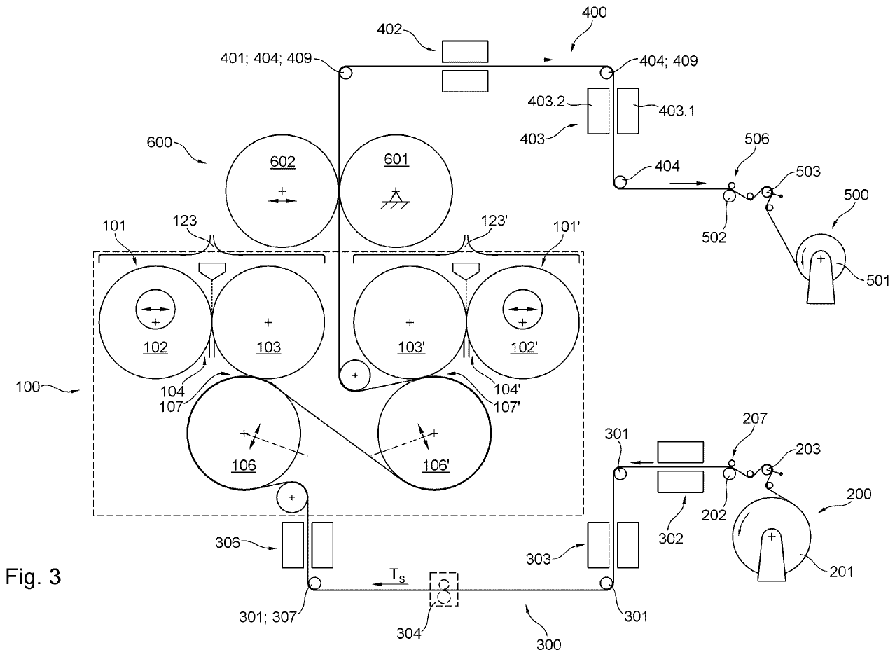

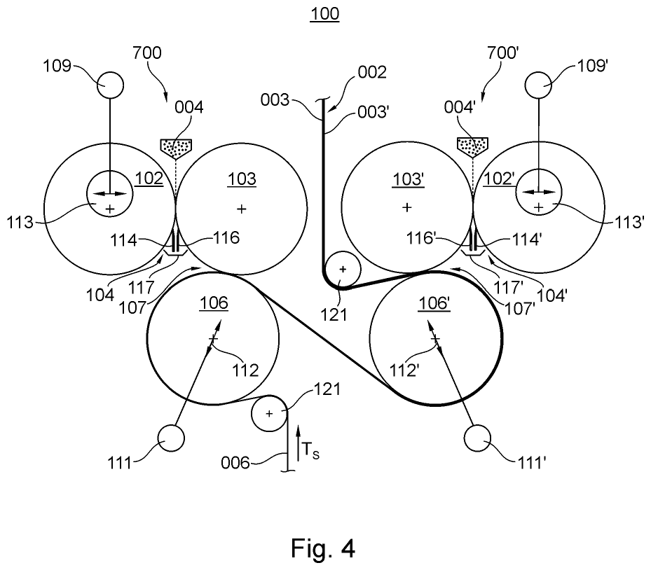

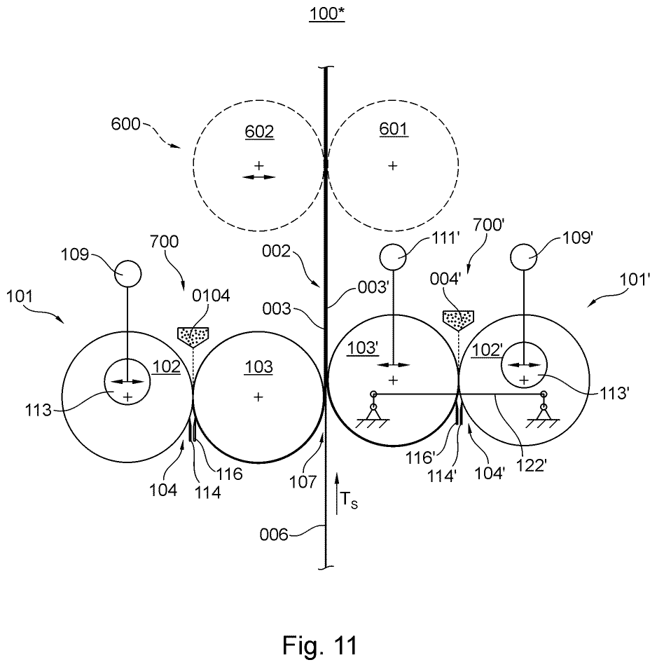

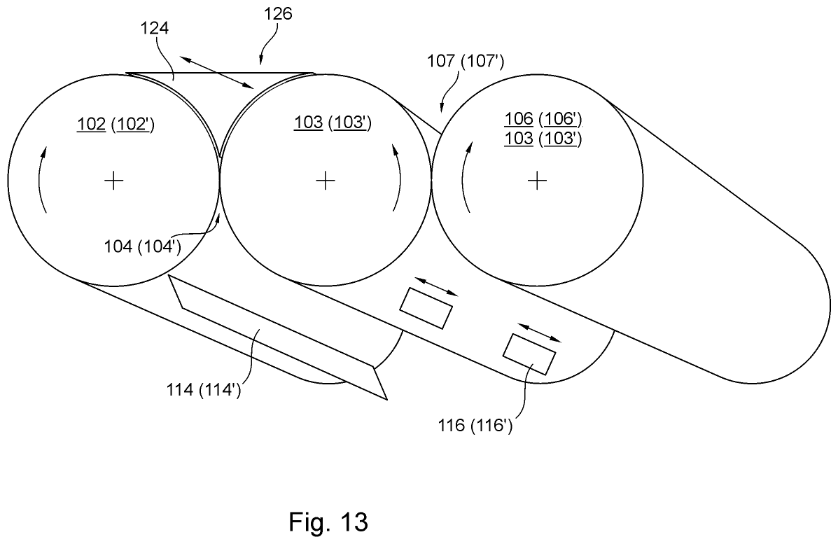

In a preferred embodiment, the application stage 100; 100* comprises a second application unit 101′ (see, for example, FIG. 3 to FIG. 13), by which likewise an, in particular solvent-free and/or dry, powder mixture 004′, which is conveyed, for example, by a second device for feeding powdered material 700′, powder feed device 700′for short, into the nip, can first be processed to a second dry film 003′; 003, in particular by way of compression and/or using a compression force, and thereafter this second dry film 003′; 003 can be applied to the other, second side of the carrier substrate 006, in particular by way of pressing and/or using a contact pressure force. This can generally be the same powder mixture 004′ or a powder mixture that differs from the first powder mixture 004′.

A first roller 102′, in particular metering roller 102′, and a second roller 103′, in particular laminating roller 103′, are also preferably provided in the second application unit 101′ so as to form, in the nip between the outer cylindrical surfaces thereof, a first gap 104′, in particular a second film-forming gap 104′, through which the powder mixture 004′ can be conveyed for forming the second dry film 003′.

Here as well, the second roller 003′of the second application unit 101′ directly, or a roller (not shown here) which cooperates with the second roller 103′ directly or indirectly via one or more further rollers and is effective as a laminating roller, in the nip between the outer cylindrical surfaces, can form a gap 107′; gap 107 with a roller 106′; 103 that is effective as the counter-pressure roller 106′; 103, through which the carrier substrate 006 can be guided and have the second dry film 003′ formed via the second film-forming gap 104′; 104 applied thereto, in particular on the second side facing away from the second counter-pressure roller 106′; 103.

In a first group of exemplary embodiments for the coating device 100 (see, for example, FIG. 3 to FIG. 7), a second gap 107′is formed by a second one application gap 107′, for example laminating gap 107′, which differs from the first one application or laminating gap 107′, with a second roller 106′, which is in particular effective as a counter-pressure roller 106 and which is effective as a second counter-pressure roller 106′different from the first counter-pressure roller 106, through which the carrier substrate 006 can be guided and have the second dry film 003′ formed via the second film-forming gap 104′ applied thereto, in particular on the second side facing away from the second counter-pressure roller 106′. In this embodiment, two independent application units 101; 101′ are provided for the two sides of the carrier substrate 106. It is thus possible to set conditions in the relevant laminating gap 107; 107′ for the particular job which independently differ from one another. For example, a different compression force or linear force and/or possibly temperature can be set.

For such an embodiment, it is possible, for example with respect to a large wrap, for the metering roller 102; 102′, the laminating roller 103; 103′ and the counter-pressure roller 106; 106′ forming the laminating gap 107; 107′ with the latter to be arranged in the respective application unit 101; 101′ in a first variant embodiment with respect to one another in such a way that the planes connecting the axes of rotation R102; R103; R106; R102′; R103′ of the respective adjacent rollers 102; 103; 106; 102′; 103′; 106′ intersect at an angle α, which is, for example, between 40° and 130°, in particular between 70° and 110°, preferably between 80° and 100°. A large wrap can cause a better heat transfer from a possibly temperature-controlled counter-pressure roller 106; 106′ and/or improved, for example flutter-free, run-up and run-off (see, for example, FIG. 3 to FIG. 5).

The particular counter-pressure roller 106; 106′ can thus, for example, be arranged beneath the laminating roller 103; 103′ in such a way that the plane connecting the axes of rotation R103; R106; R103′ of the two rollers 103; 103′; 106; 106′ deviates from the vertical by no more than ±30°, in particular no more than ±15°. In the process, the compression force in the laminating gap and gravitation act predominantly in the same direction.

In a second variant embodiment, which is advantageous, for example, with respect to the effective forces and load directions, the metering roller 102; 102′, the laminating roller 103; 103′ and the counter-pressure roller 106; 106′ forming the laminating gap 107; 107′ with the latter are arranged, for example, in such a way with respect to one another in the respective application unit 101; 101′ that the planes connecting the axes of rotation R102; R103; R106; R102′; R103′ of the rollers 102; 103; 106; 102′; 103′; 106′, which are in each case adjacent in pairs, intersect at the most at an acute angle α that is no more than 20 degrees, in particular 0 degrees, so that the axes of rotation R102; R103; R106; R102′; R103′ of the three rollers 102; 103; 106; 102′; 103′; 106′ of the same application unit 101; 101′ are located in the same plane. This makes the arrangement very rigid since the forces and counter-forces are at least predominantly directed against one another.

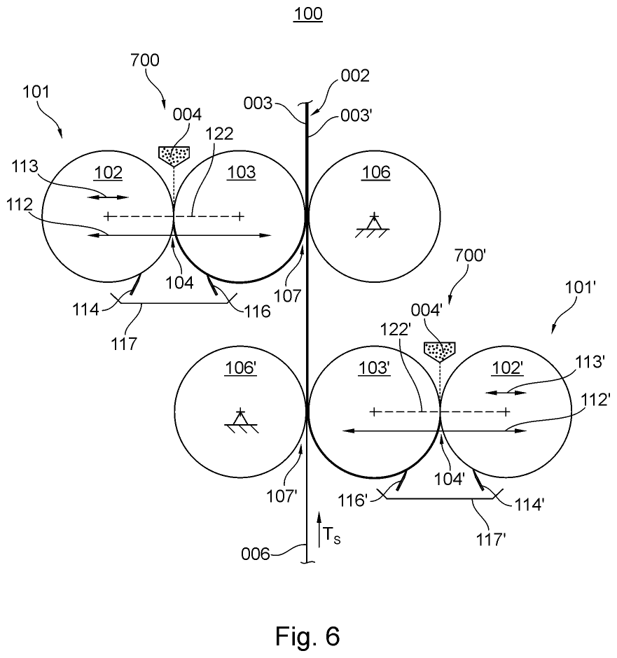

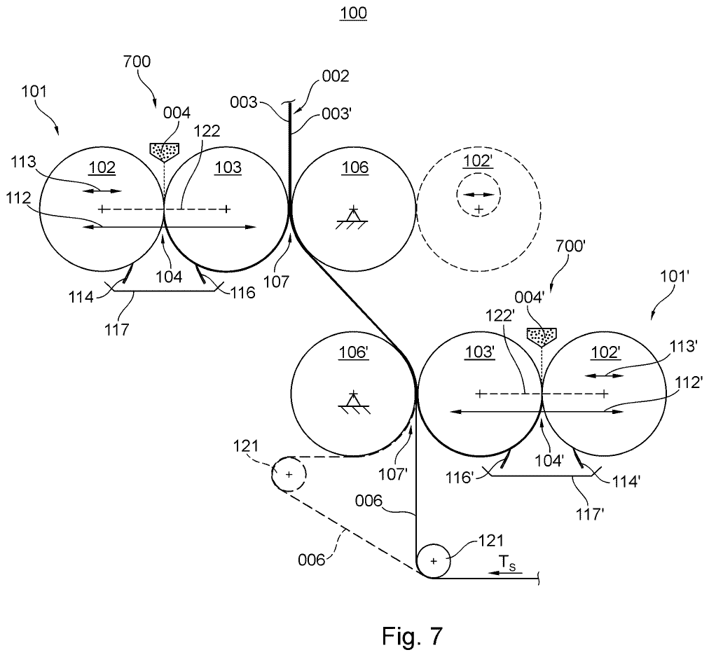

The two application units 101; 101′ are located with the laminating rollers 103; 103′ thereof on different sides of the substrate path and can be arranged on top of one another in such a way that the two laminating gaps 107; 107′ in one embodiment are located vertically directly on top of one another (see, for example, FIG. 6) or in another embodiment are horizontally offset from one another, in particular by at least half a laminating roller diameter and no more than one and a half laminating roller diameter (see, for example, FIG. 7). Based on FIG. 7, a substrate guidance that can also be applied to other embodiments is indicated by way of example by a dotted line, by way of which a larger wrap angle, and thus better heat transfer and/or more stable run-up, can be implemented. For this purpose, the substrate path is or is being deflected by an additional substrate guide element 121 in such a way that the transport direction Ts during the run-up on the succeeding roller 106; 106′ runs at least 45° inclined with respect to the transport direction T_{S} of the exiting substrate 006.

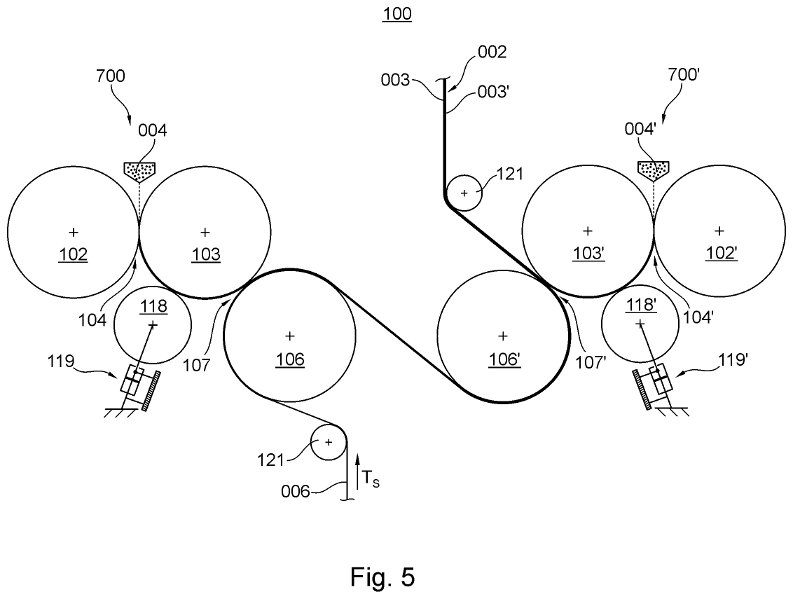

In addition to the metering roller 102; 102′, the second roller 103; 103′ or a roller that cooperates with the second roller directly or indirectly via one or more further rollers and is effective as a laminating roller, a further roller 118; 118′ (see, for example, by way of example for all embodiments of the first group in FIG. 5) can be provided in an advantageous refinement, which in a circumferential section, which during normal operation, that is, during production operation, guides the dry film 003; 003′, between the metering gap 104; 104′ and laminating gap 107; 107′, the laminating roller 103; 103′ in the form of a calendering roller 118; 118′ can be placed against a dry film 003; 003′ that is to be guided or is guided on the laminating roller 103; 103′.

For the above-described embodiments, variant embodiments and specific embodiments, it is possible, in a first configuration of the roller mount, for the laminating roller 103; 103′ of the respective application unit 101; 101′ to be mounted so as to be stationary, during normal operation, with the axis of rotation R103; R103′ thereof, even though it may be adjustable in the position thereof, and for the metering roller 102; 102′ and the counter-pressure roller 106; 106′ in each case to be mounted so as to be adjustable in a direction having at least one movement component toward the assigned laminating roller 103; 103′ and/or away therefrom by way of respective positioning drives 109; 109′; 111; 111′. Here and hereafter, the term of a positioning drive 109; 109′; 111; 111′ shall be understood to mean the entirety of the means that effectuate and/or enable the direct or indirect adjustment of a roller 102; 102′; 103; 103′; 106; 106′, which hereafter are also referred to as positioning means 109; 109′; 111; 111′, and encompasses at least one positioning mechanism 112; 112′; 113; 113′ guiding the roller 102; 102′; 103; 103′; 106; 106′ along an adjustment movement as well as one or more drive means effectuating the adjustment. For placing the respective metering roller 102; 102′ against the second roller 103; 103′, a position-based positioning drive 109; 109′ or positioning means 109; 109′ is provided in a first design for a position-based adjustment, that is, a positioning drive 109; 109′ or positioning means 109; 109′ by way of which the component to be adjusted can be moved into a defined position. Such a position-based positioning drive 109; 109′ can be implemented, for example, by a drive means, for example drive motor, itself being able to assume a defined and specifiable position, such as is possible, for example, for a closed loop position-controlled servo drive or motor, or by an adjustment path, at least toward the relevant side, being delimited by a stop that can be adjusted by way of drive means, which defines the end position and against which the component to be adjusted in terms of the position is placed or can be placed by means of a, for example, force-based or not positionally accurate drive means. The roller 102; 102′ is mounted, for example, in or at a positioning mechanism 112; 112′; 113; 113′ which is formed by a bearing mechanism 112; 112′; 113; 113′ implementing the adjustment path, for example, in a positionally accurate manner. Such a mechanism is advantageously provided, for example, by a bearing 113; 113′ comprising an eccentric, for example a triple ring bearing 113; 113′, in particular for small adjustment paths at large forces. With respect to, for example, a position that is parallel to the adjustment direction and thus more direct in terms of the adjustment path, however, a linear bearing 112; 112′ extending in the adjustment direction may also be advantageous instead.

For adjusting the respective counter-pressure roller 106; 106′, a force-based positioning drive 111; 111′ or positioning means 111; 111′ is or are provided in this first advantageous design for a force-based adjustment, that is, a positioning drive 111; 111′ or positioning means 111 by way of which a throwing-on with a defined force against the abutment can be implemented. Such a positioning drive 111; 111′, which is in particular force-based on at least one side, can be implemented, for example, in that a drive means, for example a drive motor, itself can apply a defined and specifiable force, such as is possible, for example, for a closed loop moment-controllable or open loop moment-controllable, in particular closed loop torque-controllable or open-loop torque-controllable servo drive or motor, or in that an adjustment force toward the relevant side can be placed against the other roller 103; 103′ by a drive means actuatable by means of a pressurized medium, for example by a pneumatically or hydraulically actuated cylinder-piston system, wherein the pressure of the drive means is preferably settable. The counter-pressure roller 106; 106′ is mounted, for example, in or at a positioning mechanism 112; 112′; 113; 113′, which is formed by a bearing mechanism 112; 112′ that implements the adjustment force in a force-based manner, that is, without additional mechanical delimitation of the adjustment path. This can advantageously be formed, for example, by a bearing mechanism 112; 112′ designed as a linear bearing 112; 112′, at least on one side, but preferably on both sides.

In a second design, however, the metering roller 102; 102′ can conversely be adjustable in a force-based manner, and the counter-pressure roller 106; 106′ can be adjustable in a position-based manner. For this purpose, what was described above must be appropriately transferred and applied.

In a third design, however, both rollers 102; 102′; 106; 106′ can be adjustable in a force-based manner, and in a fourth design both rollers 102; 102′; 106; 106′ can be adjustable in a position-based manner. For this purpose, what was described above must be appropriately transferred and applied.

In a particularly advantageous fifth design, a combined positioning mechanism 112; 113; 112′; 113′ and/or a combined positioning drive 109; 109′; 111; 111′ or combined positioning means 109; 109′; 111; 111′ are provided for adjusting at least the metering roller 102; 102′ and/or at least for adjusting the counter-pressure roller 106; 106′, which selectively allows a position-based adjustment of the relevant roller 102; 102′; 106; 106′ or a force-based adjustment. Such a combined positioning drive 109; 109′; 111; 111′ can be formed, for example, by a positioning drive 109; 111; 109′; 111′ or positioning means 109; 111; 109′; 111′ comprising a drive means that can be controlled in terms of the force, for example a cylinder-piston system that can be acted on by a pressurized fluid, and comprising a positioning mechanism 112; 112′; 113; 113′, in the adjustment path of which selectively one or more stops, which can be positioned by way of positioning means, can be introduced for limiting the position. As an alternative or in addition, a positioning drive 109; 111; 109′; 111′ which comprises, as drive means, a selectively closed loop position-controlled or open loop position-controlled or closed loop moment-controlled or open loop moment-controlled motor, in particular servo motor, can also be advantageous for this purpose.

In a second configuration for the roller mounting, the counter-pressure roller 106; 106′ of the respective application unit 101; 101′ can be mounted so as to be stationary, during normal operation, with the axis of rotation R106; R106′ thereof, even though it may be adjustable, and the laminating rollers 103; 103′, with the respective assigned metering roller 102; 102′, can be mounted so as to be adjustable in pairs in a direction having at least one movement component toward the assigned counter-pressure roller 106; 106′ and/or away therefrom by way of respective shared bearing mechanisms 112; 112′ and/or positioning drives 111; 111′, and additionally the respective metering rollers 102; 102′ can be mounted so as to be adjustable in a direction having at least one movement component toward the respective assigned laminating roller 103; 103′ and/or away therefrom by way of bearing mechanisms 112; 112′; 113; 113′ and/or positioning drives 109; 109′; 111; 111′.

In a first advantageous design, a position-based positioning drive 109; 109′ within the above meaning, for example a bearing mechanism 112; 112′; 113; 113′ formed by a triple ring bearing 113; 113′ or by a linear bearing 112; 112′ can be provided for this purpose, for example on one side or both sides, for adjusting the respective metering roller 102; 102′. A force-based positioning drive 111; 111′ within the above meaning can be provided for adjusting the laminating rollers 103; 103′ in pairs with the respective assigned metering roller 102; 102′.

In a second design, however, the metering roller 102; 102′ can conversely be adjustable in a force-based manner, and the roller pair 103, 102; 103′, 102′ can be adjustable in a position-based manner. For this purpose, what was described above must be appropriately transferred and applied.

In a third design, however, the metering roller 102; 102′ and the roller pair 103, 102; 103′, 102′ can be adjustable in a force-based manner, and in a fourth design the metering roller 102; 102′ and the roller pair 103, 102; 103′, 102′ can be adjustable in a position-based manner. For this purpose, what was described above must be appropriately transferred and applied.

In a particularly advantageous fifth design, a combined positioning mechanism 112; 113; 112′; 113′ is provided for adjusting at least the metering roller 102; 102′ and/or at least for adjusting the roller pair 103; 102; 103′, 102′ within the above meaning and/or in the above embodiment, which selectively allows a position-based or force-based adjustment of the pair toward the counter-pressure roller 106; 106′; 103′; 103.

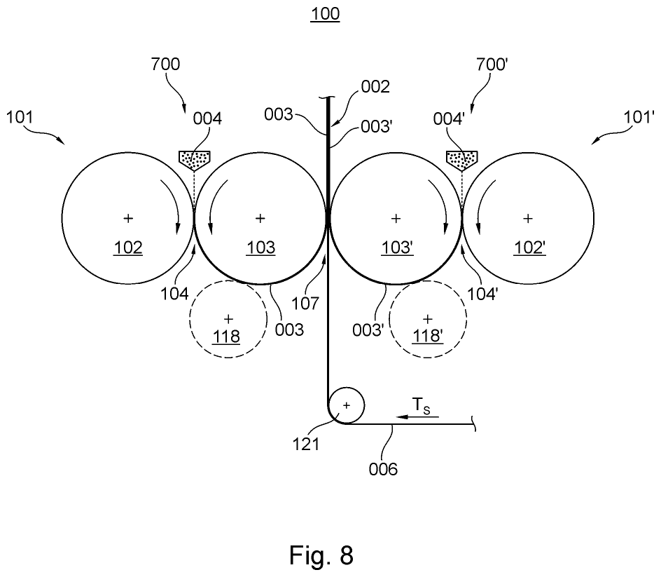

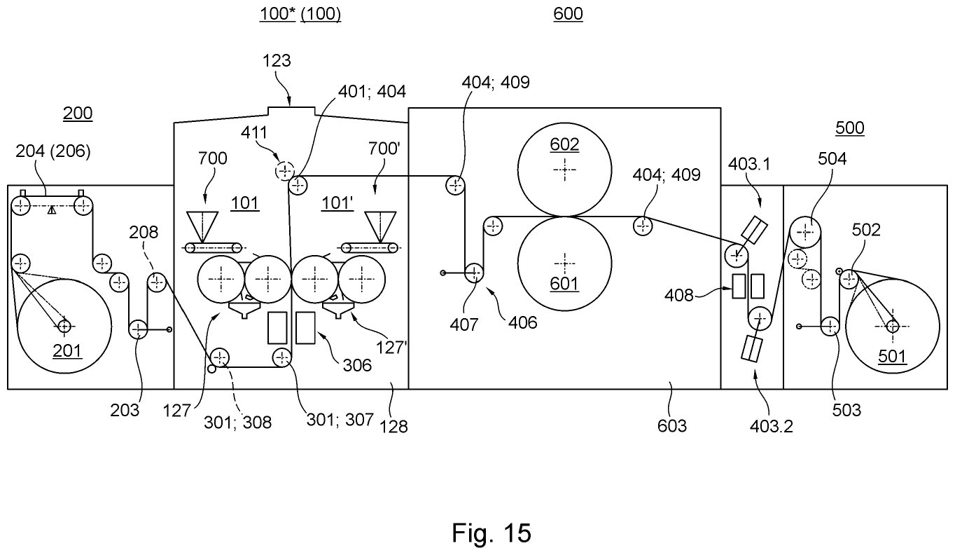

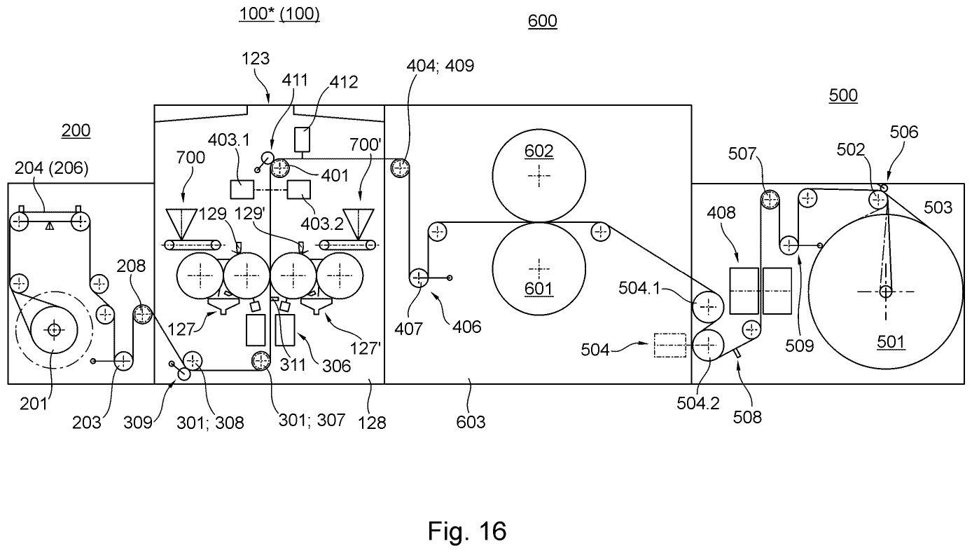

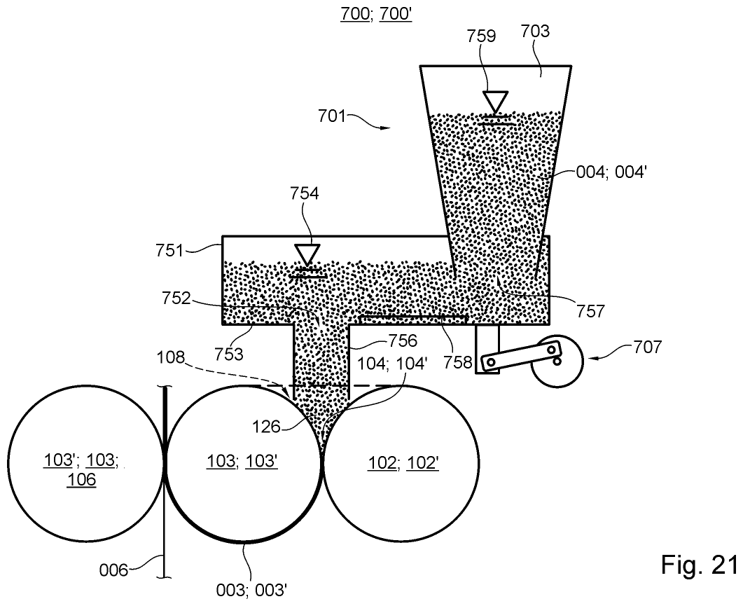

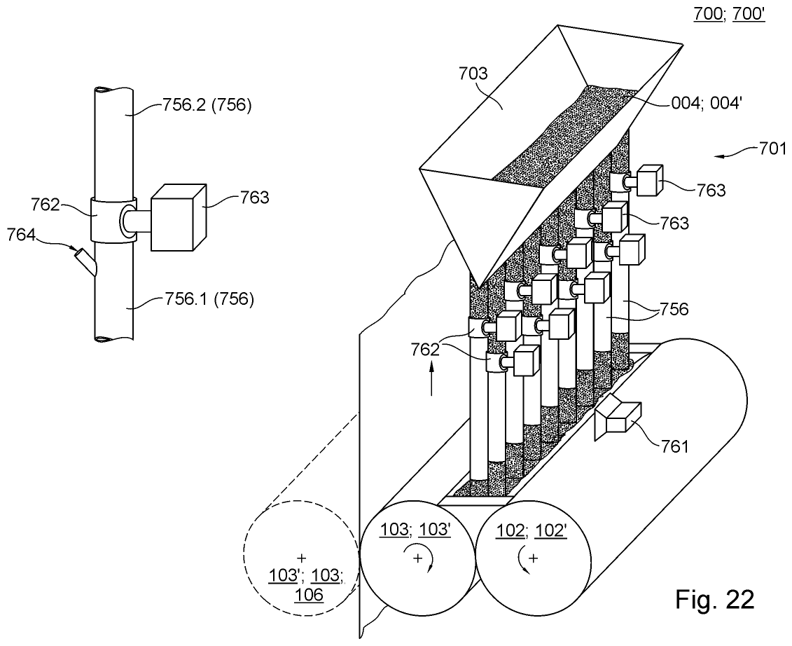

In a second group of exemplary embodiments for the coating device 100* (see, for example, shown in FIG. 8 to FIG. 12, FIG. 15, FIG. 16, FIG. 21 and FIG. 22), the second roller 003′ of the second application unit 101′ or a roller of the second application unit 101′ cooperating with the second roller 103′ directly or indirectly via one or more further rollers, together with the second or further roller 103 of the first application unit 101 effective as the laminating roller 103, in a nip between the outer cylindrical surfaces thereof, form a shared gap 107 that is effective as a two-sided laminating gap 107, wherein the two laminating rollers 103; 103′ forming the gap 107 between each other are effective with respect to one another as counter-pressure rollers 103′; 103. The carrier substrate 006 can be guided through the latter and has the respective dry film 003′; 003 formed via the first and second film-forming gaps 104; 104′ applied thereto, in particular on both sides. Such an arrangement of two application units 101; 101′ cooperating for the simultaneous two-sided application is also referred to hereafter as a double application unit 101, 101′.

The planes formed in the respective application unit 101; 101′ by the axes of rotation R102; R103; R102′; R103′ of the metering roller 102; 102′ and the laminating roller 103; 103′, for example, intersect at the most at an acute angle α, which, for example, is no more than 20° degrees, advantageously no more than 5°, in particular 0°, so that in the latter case the axes of rotation R102; R103; R106; R102′; R103′ of the rollers 102; 103; 106; 102′; 103′; 106′ of the two application units 101; 101′ cooperating in a two-sided laminating gap 107 are located in the same plane or extend parallel to, but vertically offset from one another.

In a first variant embodiment, the two planes extend in a shared horizontal plane or horizontally, but vertically offset from one another (see, for example, FIG. 8).

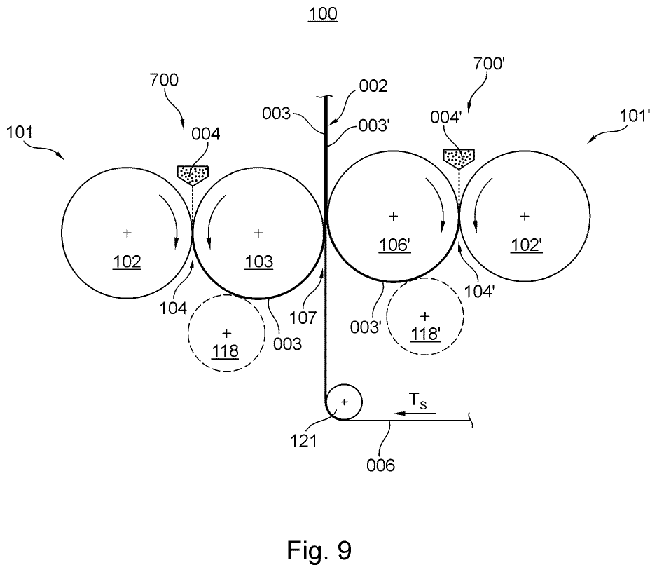

In a second advantageous variant embodiment, for example with respect to a smaller wrap, the two planes extend in a shared plane that is inclined with respect to the horizontal or in two planes that are inclined with respect to the horizontal, but are offset vertically from one another. The shared plane is, or the two offset planes are, for example, inclined with respect to the horizontal by an acute angle β of 2° to 15°, in particular 3° to 10° (see, for example, FIG. 9).

In addition to the respective metering roller 102; 102′ and the second roller 103; 103′, in an advantageous refinement a further roller 118; 118′ in the above-described form of a calendering roller 118; 118′ can also be provided here (see, for example, by way of example dotted for all embodiments of the second group in FIG. 8 and FIG. 9).

For the above-described variant embodiments and specific embodiments, in a first configuration of the roller mount, a first of the two laminating rollers 103 or a further roller, effective as a laminating roller, of a first of the two application units 101 can be mounted so as to be stationary, during normal operation, with the axis of rotation R103 thereof, even though it may be adjustable, while the second of the laminating rollers 103′ or a further roller, effective as a second laminating roller, together with the assigned metering roller 102; 102′, are mounted so as to be adjustable in pairs in a direction having at least one movement component toward the assigned counter-pressure roller 106; 106′ and/or away therefrom by way of a shared bearing mechanism 112; 112′ and/or a shared positioning drive 109; 109′; 111; 111′, and additionally the respective metering rollers 102; 102′ are mounted so as to be adjustable in a direction having at least one movement component toward the respective assigned laminating roller 103; 103′ or further roller and/or away therefrom by way of bearing mechanisms 112; 112′; 113; 113′ and/or positioning drives 109; 109′; 111; 111′. If one or more further rollers are present between the metering roller 102; 102′ and the roller effective as a laminating roller, these are, for example, also adjustable together in a direction having at least one movement component toward the assigned counter-pressure roller 106; 106′ and/or away therefrom by way of the shared bearing mechanism 112; 112′ and/or the shared positioning drive 109; 109′; 111; 111′.

For the adjustment of the respective metering roller 102; 102′, a position-based positioning drive 109; 109′ within the above meaning is provided within the above meaning and/or in an above-described embodiment in a first advantageous design. For the adjustment of the second laminating roller 103′ in pairs with the assigned metering roller 102′, a force-based positioning drive 111; 111′ within the above meaning can be provided for a force-based adjustment within the above meaning and/or in an above-described embodiment.

In a second design, however, the metering roller 102; 102′ can conversely be adjustable in a force-based manner, and the roller pair 103, 102; 103′, 102′ can be adjustable in a position-based manner. For this purpose as well, what was described above must be appropriately transferred and applied.

In a third design, however, both rollers 102; 102′; 106; 106′ can be adjustable in a force-based manner, and in a fourth design both rollers 102; 102′; 106; 106′ can be adjustable in a position-based manner. For this purpose, what was described above must be appropriately transferred and applied.

In a particularly advantageous fifth design, a combined positioning mechanism 112; 113; 112; 113 is provided for adjusting at least the metering roller 102; 102′ and/or at least for adjusting the roller pair 103; 102; 103′, 102′ within the above meaning and/or in the above embodiment, which selectively allows a position-based adjustment of the pair against the laminating roller 103′; 103 effective as a counter-pressure roller 103′; 103 via a position-based positioning drive 109; 109′ and a force-based adjustment via a force-based positioning drive 111; 111′.

For all embodiments of the two groups of exemplary embodiments comprising jointly adjustable rollers 103′; 102′; 103; 102, these can be mounted on both sides in carriers 122′; 122, in particular in side parts of a subframe, which, in turn, are mounted by way of bearing mechanisms 112′; 112 formed by linear bearings 112′; 112 in a frame receiving the application units 101; 101′.

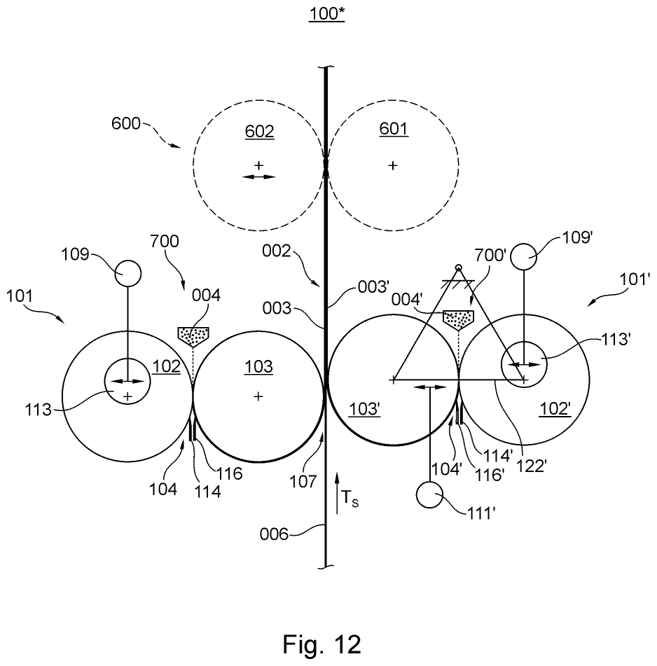

As an alternative, the two jointly adjustable rollers 102; 103; 103′; 102′, however, can be mounted on both sides in carriers, in particular in side parts of a subframe, which, in turn, are mounted so as to be pivotable about a pivot axis that is parallel to the axis of rotation of the first laminating roller 103; 103′ mounted in a stationary manner (see, for example, FIG. 12).

As was already mentioned, at least one further roller, which is effective as a laminating roller and, together with the counter-pressure roller 106; 103′, forms the laminating gap 107; 107′, can be provided in a respective application unit 101; 101′ between the second roller 103; 103′ and the nip point for the counter-pressure roller 106; 103′.

For all embodiments of the two groups of exemplary embodiments, in a particularly advantageous refinement a material removal unit 127; 127′, comprising, for example, a removal device 114; 114′, which, for cleaning purposes, can be selectively placed against and be removed from the outer cylindrical surface of the first roller 102; 102′, in particular a cleaning squeegee 114; 114′, is provided in the respective application unit 101; 101′. This removal device extends, for example, at least across the width of the cylindrical roller surface which is effective for forming the film.

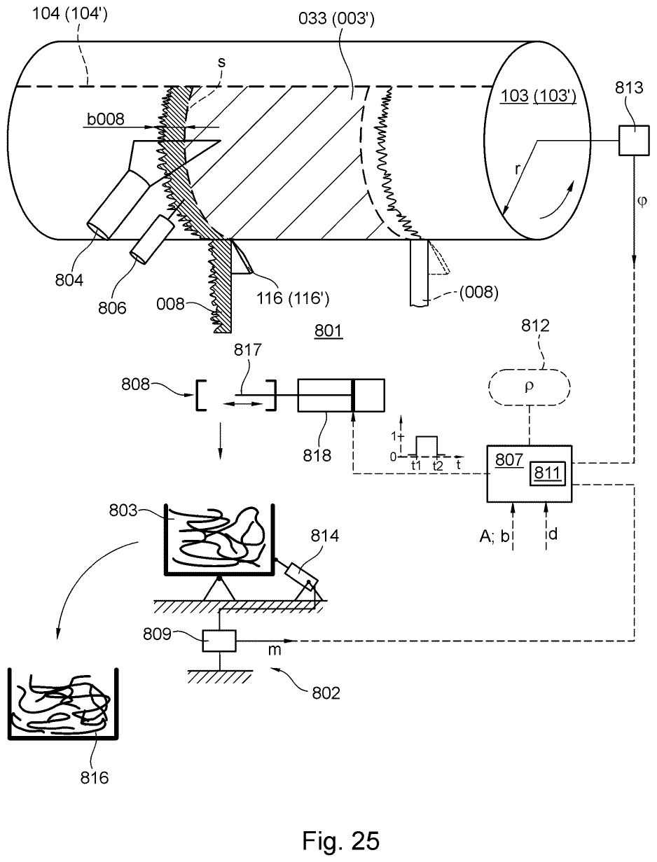

Instead or advantageously in addition, the material removal unit 127; 127′ in the respective application unit 101; 101′, viewed axially parallel to the second roller 103; 103′, comprises spaced apart from one another two axially parallel adjustable removal devices 116; 116′, which can be placed against or removed from the second roller 103; 103′, in particular a side edge squeegee 116; 116′, by which a dry film 003; 003′ that is conveyed over the second roller 103; 103′ can be removed in the region of the lateral edges thereof and, for example, be transferred into a collecting device 117; 117′. This removal serves, for example, as a so-called trimming of the edge, to preserve a straight edge and/or a desired width b003; b003′ of the dry film 003; 003′. The collected amount can, for example, be returned to the infeed of the powder mixture 004; 004′. Such a removal device 116; 116′ can also be used to remove an edge strip 008; 008′, which is used, for example, during the determination of a density p of the material layer 003; 003′, such as is set out below, for example, in connection with FIG. 25, for example.

For cleaning purposes, a removal device 129; 129′ that can be placed against and removed from the outer cylindrical surface of the second roller 103; 103′, in particular a cleaning squeegee 129; 129′, can also advantageously be provided, which, for example, extends at least over the width of the cylindrical roller surface which is effective for forming the film, and possibly an extraction or collecting device, which is not shown.

For feeding or introducing the powder mixture 004; 004′ into the first gap 004; 004′, in a particularly advantageous refinement, for example, two boundaries 124, which are spaced apart from one another axially parallel to the first roller 102; 102′ and are preferably adjustable in the axially parallel direction, in particular side shields 124, are provided in the application unit 101; 101′ above the first gap 104; 104′, which each seal off a region of the upper wedge-shaped space 108 formed between the outer cylindrical surfaces of the first and second rollers 102; 103; 102′; 103′, that is, in the wedge-like or triangle-like or triangular space 108 located above the gap 104; 104′ between the outer cylindrical surfaces, toward the two end faces of the application unit 101; 101′, and in this way form an interposed filling and/or supply chamber 126, which can preferably be varied in terms of the width, for receiving the powder mixture 004; 004′. Depending on the desired width and/or position of the dry film 003; 003′, the filling and/or supply chamber 126 can thus be varied or be variable on at least one side, preferably on both sides, in terms of the position of the lateral boundary 124 thereof. The above-described wedge-shaped space 108 or wedge-like or triangle-like or triangular space 108 between the two rollers 102; 103; 102′; 103′ has concave lateral surfaces toward the outer cylindrical surfaces and ends with the tangent surface connecting the two cylindrical roller surfaces. As an alternative to a filling and/or supply chamber 126 that is directly delimited by the outer cylindrical surfaces in the lower region, generally a filling and/or supply chamber 126 in the form of a filling or supply hopper could also be provided, at least where this does not contradict other design features of the application unit 101; 101′ or of the powder feed unit 700; 700′, for example in a manner comparable to an insertion aid described below, directly in or above the wedge-shaped space 108.

For all above-described embodiments, variants, configurations, specific embodiments or designs, the bearing mechanism 112; 112′; 113; 113′ and/or the positioning drive 109; 109′; 111; 111′ of the first roller 102; 102′ is preferably designed in such a way that a gap width for the first gap 104; 104′, during normal operation, can be set to a variable inside width at the narrowest point of at least 15 μm, advantageously of at least 30 μm, in particular of at least 50 μm, and/or that the gap width of the first gap 104; 104′ can at least be set by way of above-described position-based drive means and/or by way of at least one-sided stop means which delimit a contact position toward the nip point and the positions of which are adjustable. As an alternative or in addition, the bearing mechanism 112; 112′; 113; 113′ and/or the positioning drive 109; 109′; 111; 111′ are advantageously designed to set and/or apply, in the first gap 104; 104′ at least in the region of the width thereof contributing to the film formation, a linear force of, for example, at least 5.0 kN/cm, advantageously at least 7 kN/cm, preferably a linear force ranging between 5 kN/cm and 30 kN/cm, between the rollers 102; 102′; 102; 103′ forming the first gap 104; 104′.

As mentioned above, a combined positioning mechanism 112; 113; 112′; 113′ can be provided for placing the metering roller 102; 102′ against the second roller 103; 103′, which selectively allows a position-based adjustment by way of a position-based positioning drive 109; 109′ and allows a force-based adjustment by way of a force-based positioning drive 111; 111′.

For all above-described embodiments, variants, configurations, specific embodiments or designs and, for example, independently of the above-described implementation of the coating device 100; 100* comprising individual discharge units 101; 101′ with respective counter-pressure rollers 106; 106′ or comprising combined discharge units 101; 101′with counter-pressure rollers 103′; 103 that are effective with respect to one another, in a particularly advantageous embodiment the metering gap 104; 104′ between the first and second rollers 102; 102′; 103; 103′ can be adjusted based on a position-based positioning drive 109; 109′ within the above meaning, that is, for example, can be set to a constant and/or defined gap width, and/or the laminating gap 107; 107′ between the second roller 103; 103′ and the counter-pressure roller 106; 106′; 103′; 103 can be adjusted within the above meaning based on a force-based positioning drive 111; 111′, that is, can be set, for example, to a constant and/or defined contact force or linear force. Without limiting the above-described specific exemplary embodiments, generally any of the two rollers 102; 102′; 103; 103′; 106; 106′ involved in the relevant gap 104; 104′; 107; 107′ can be mounted so as to be adjustable by the corresponding positioning drive 109; 109′; 111; 111′ and/or at corresponding positioning mechanisms 112; 112′; 113; 113′ within the above meaning. This also applies to embodiments in which a roller 102; 102′; 103; 103′; 106; 106′ that is involved in the relevant gap 104; 104′; 107; 107′, together with another roller 102; 102′; 103; 103′; 106; 106′ that is not involved in this gap 104; 104′; 107; 107′, are mounted so as to be jointly adjustable in this manner.

Likewise, for example, independently of the above-described implementation of the coating device 100; 100* comprising individual discharge units 101; 101′ with respective counter-pressure rollers 106; 106′ or comprising combined discharge units 101; 101′ with counter-pressure rollers 103′; 103 that are effective with respect to one another, in a particularly advantageous embodiment with respect to the optimal adjustability the metering gap 104; 104′ between the first and second rollers 102; 102′; 103; 103′ of the same application unit 101; 101′ and/or the laminating gap 107; 107′ between the second roller 103; 103′ and the cooperating counter-pressure roller 106; 106′; 103′; 103, are designed so as to be adjustable, for example not just merely in a position-based or force-based manner but, based on a combined positioning drive 109; 109′; 111; 111′ selectively in a position-based or force-based manner, and/or a roller 102; 102′; 103; 103′; 106; 106′ that is involved in the relevant gap 104; 104′; 107; 107′ is mounted in a combined positioning mechanism 112; 113; 112′; 113′ so as to be selectively adjustable in a position-based or force-based manner and/or the relevant gap 104; 104′; 107; 107′ can be selectively set to a constant and/or defined gap width or to a constant and/or defined contact force or linear force. Without limiting the above-described specific exemplary embodiments, here as well generally any of the two rollers 102; 102′; 103; 103′; 106; 106′ involved in the relevant gap 104; 104′; 107; 107′ can be adjustable by the corresponding combined positioning drive 109; 109′; 111; 111′ and/or can be accordingly mounted at corresponding combined positioning mechanisms 112; 112′; 113; 113′ within the above meaning. This also applies to embodiments in which a roller 102; 102′; 103; 103′; 106; 106′ that is involved in the relevant gap 104; 104′; 107; 107′, together with another roller 102; 102′; 103; 103′; 106; 106′ that is not involved in this gap 104; 104′; 107; 107′, are mounted so as to be jointly adjustable in this manner.

The first roller 102; 102′ can be mounted so as to be adjustable in a direction having at least one movement component toward the respective assigned second roller 103; 103′ and/or away therefrom by way of a bearing mechanism 113; 113′; 112; 112′ and/or a, for example, position-based or force-based or selectively position-based or force-based positioning drive 109; 109′; 111; 111′. In addition or instead, the counter-pressure roller 106; 106′; 103′; 103 can be mounted so as to be adjustable in a direction having at least one movement component toward the second or an interposed further roller 103; 103′ and/or away therefrom by way of a bearing mechanism 113; 113′; 112; 112′ and/or a, for example position-based or force-based or selectively position-based or force-based positioning drive 109; 109′; 111; 111′.

As an alternative, the first roller 103; 103′, together with the assigned second roller 102; 102′, can be mounted so as to be movable in pairs in a direction having at least one movement component toward the assigned counter-pressure roller 106; 106′ and/or away therefrom by way of a shared bearing mechanism 112; 112′; 113; 113′ and/or a shared, for example, position-based or force-based or selectively position-based or force-based positioning drive 109; 109′; 111; 111′, and additionally the respective first roller 102; 102′ can be mounted so as to be adjustable in a direction having at least one movement component toward the respective assigned second roller 103; 103′ and/or away therefrom by way of a bearing mechanism 113; 113′; 112; 112′ and/or a, for example, position-based or force-based or selectively position-based or force-based positioning drive 109; 109′; 111; 111′.

For all above-described embodiments, variants, configurations, specific embodiments or designs, the first roller 102; 102′ and the second roller 103; 103′ forming the first gap 104; 104′ therewith can be driven or are driven mechanically independently of one another during normal operation in opposite directions and at differing circumferential speeds and/or by differing drive motors, in particular at least speed-controllable, by closed-loop or open-loop control, servo motors.

In the process, the first roller 102; 102′ is operated at a lower speed, wherein the first roller 102; 102′, in particular the metering roller 102; 102′, and the assigned second roller 103; 103′, in particular the laminating roller 103; 103′, during normal operation, can be operated or are operated, for example, at a ratio V102(102′):V103(103′) of the circumferential speed of the first to the second roller 102, 102′; 103; 103′ which is in a range of 1:5 to 3:5, in particular 1:4.

During normal operation, the rollers 103; 106; 106′; 103′ forming the second gap 107; 107′ with one another are preferably drivable or driven mechanically independently of one another at the same circumferential speed by a shared drive motor, in particular servo motor, or preferably by differing drive motors, in particular servo motors.

In an advantageous embodiment, the drive motors that are mechanically independent of one another can be operated via an electronic, in particular virtual master axis by a drive controller.

Of particular advantage is a refinement in which the first roller 102; 102′, in the region of the outer cylindrical surface thereof contributing to the film formation, has a stronger material-repellent surface with respect to the powder mixture and/or a less strongly adhesively acting outer cylindrical surface than the second roller 103; 103′ in the region of the outer cylindrical surface contributing to the film formation.

At least the second roller 102; 102′; 103; 103′ can have a polished and/or chrome-plated or ceramic-coated surface, at least in the region of the outer cylindrical surface contributing to the film formation. The first roller 102; 102′ can have a structured or material-repellent surface, at least in the region of the outer cylindrical surface contributing to the film formation.

For all above-described embodiments, variants, configurations, specific embodiments or designs, the first and/or the second rollers 102; 102′; 103; 103′ can be heated, in particular in such a way that the outer cylindrical surface thereof can be heated at an ambient temperature of 25° C. to at least 80° C., advantageously to at least 100° C., preferably to at least 120° C.

Instead or preferably in addition, the roller 106; 106′ of the first group of exemplary embodiments which is only effective as a counter-pressure roller 106; 106′; 103; 103′ can also be heated, in particular in such a way that the outer cylindrical surface thereof can be heated at an ambient temperature of 25° C. to at least 80° C., advantageously to at least 100° C., preferably to at least 120° C.

The temperature control or heating can generally be carried out electrically, however in an advantageous embodiment is implemented by conducting a temperature-control or heating fluid through the roller 102; 102′; 103; 103′; 106; 106′ of which the temperature is to be controlled. In the process, the temperature control fluid, for example accordingly temperature-controlled water, is supplied to and removed from the roller 102; 102′; 103; 103′; 106; 106′ of which the temperature is to be controlled via a temperature-control fluid line and, for example, a rotary union in the relevant roller 102; 102′; 103; 103′; 106; 106′.

For all above-described embodiments, variants, configurations, specific embodiments or designs, the two application units 101; 101′ are mounted together with one or more substrate guide elements 121, which may be arranged directly upstream, downstream or therebetween, in a shared frame, for example, two end-face side walls of the same frame. In this way, a compact and/or inherently rigid and/or defined arrangement of the application units 101; 101′ can be provided in a laminating unit 100; 100* designed as a subassembly 100; 100*, for example laminating subassembly 100; 100*.

If a calendering unit 600; 600*, which is described below, for example, is provided directly downstream in the substrate path, in an advantageous refinement rollers 601; 601′; 602; 602* comprised by the calendering unit 600; 600* can likewise be mounted in this frame 603 or, in an advantageous variant, for example, as a separate subassembly 600; 600*, for example calendering subassembly 600; 600*, in side walls of a dedicated frame 603 that is arranged directly on and/or over the frame 128 carrying the application units 101; 101′.

In an advantageous embodiment of the machine shown, for example, in FIG. 15, which may have a slightly longer design, in which, however, the risk of transmitting vibrations between the subassemblies 100; 100*; 600; 600*, in particular at least the laminating subassembly 100; 100* and the calendering subassembly 600; 600*, is decreased, the laminating subassembly 100; 100* and the calendering subassembly 600 are provided horizontally next to one another, preferably even in dedicated frames 128; 603, which, for example, are separated from one another in terms of vibration.

For all above-described embodiments, variants, configurations, specific embodiments or designs, the bearing mechanism 112; 112′; 113; 113′ and/or the positioning drive 109; 109′; 111; 111′ of the rollers 103; 103′; 106; 106′ forming the second gap 107; 107′ are preferably designed to form, during normal operation, a gap width of at least 15 μm, advantageously of at least 30 μm, in particular of at least 50 μm, at the narrowest point and/or, in particular at least within boundaries defining the maximum adjustment path, to form a gap width arising between the two rollers 103; 103′; 106; 106′ via a product strand 002; 002′ to be formed and/or a contact pressure force or linear force caused by at least one positioning mechanism 112; 112′ and/or at least one positioning drive 109; 109′, and/or to set and/or apply, in the second gap 107; 107′ at least in the region of the width contributing to the film formation, a linear force of, for example, at least 5.0 kN/cm, advantageously at least 7 kN/mm, preferably a linear force between 5 kN/cm and 30 kN/cm, between the rollers 103; 103′; 106; 106′ forming the second gap 107; 107′, and/or to enable keeping a desired linear force constant, even if the dry film thickness

fluctuates, by repositioning at least one of the two rollers 103; 106; 103; 103′ automatically or in a controlled manner.

For all above-described embodiments, variants, configurations, specific embodiments or designs, in a particularly advantageous refinement an extraction unit 123; 123′, by which potentially leaking gases or developing fumes can be extracted, is provided above the respective application unit 101; 101′ or the application units 101; 101′.

The rollers 102; 102′; 103; 103′; 106; 106′ of the above-described application units 101; 101′ are preferably designed with a width in the range of 400 mm to 800 mm, in particular of 500 mm to 700 mm which can be used for film formation and/or for application.

Even though, generally, an arbitrarily designed device for feeding powdered material 700; 700′ can be provided, by which powder mixture 004 can be fed to the application unit 101; 101′ in the first gap 104; 104′ formed between the first and second rollers, particularly preferably a feed unit 700; 700′ is provided, by which a defined and/or controllable stream of powder mixture 004 can be fed evenly across the entire dispensing width to the gap 104; 104′ directly or indirectly via an insertion aid 711 that is provided above the roller gap 104; 104′, for example in the form of a funnel-shaped pan 711. In this regard, particularly advantageous embodiments for the device for feeding powdered material 700; 700′ in various respects are provided hereafter, which can be provided alone or advantageously in conjunction with any embodiment or design of the described application units 101; 101′ and/or coating devices 100; 100* and/or machine configurations. The devices for feeding powdered material 700; 700′ shown in the figures with respect to the designs of the application units 101; 101′ and/or coating devices 100; 100* and/or machine configurations can merely be schematically understood and be formed by one of the following embodiments.

In a preferred embodiment, the device for feeding the powdered material 700; 700′ can comprise a dispensing device 701 which controls and/or defines the amount to be dispensed, which, for example, is designed in the form of a metering device 701 or at least comprises a metering unit 704; 721. A dispensing device 701 designed as a metering device 701 or comprising a metering unit 704; 721 can generally be arbitrarily designed in a wide variety of ways so as to be able to dispense a controlled stream of material 004; 004′ in the above-described manner. In a preferred embodiment, the stream of powdered material 004; 004′ can be dispensed by means of the dispensing device 701 to a conveying device 702 following downstream, for example a linear conveyor 702 that is preferably designed as a conveyor belt 702. Using this conveying device 702, the powdered material 004; 004′ can be conveyed downstream, for example on a conveying width extending transversely to the conveying direction T_{P}, in the form of bulk powder or a powder layer and can, on the output side, be fed directly to the nip 104; 104′ or the possibly provided insertion aid 711, preferably directly or possibly indirectly, for example via one or more further conveying devices, over a feed width extending transversely to the conveying direction T_{P}. The conveying device 702, in particular a roller 705 around which the conveyor belt 702 is wrapped, for example a diverting roller 705, in particular a drive roller 705, can preferably be varied in terms of the conveying speed and, for example, be driven by a drive means 712 that can be varied in terms of the speed, for example a drive motor 712, in particular a servo motor 712. So as to promote the transport, the surface of a conveying device 702 designed as a conveyor belt 702 can preferably be rough and/or can have a downwardly sloping inclination in the conveying direction T_{P}. The feed width here corresponds exactly or at least approximately, that is, with a maximum deviation of, for example, ±10%, to a supply width of a filling and/or supply chamber 126 which is delimited on both sides in terms of the width and receives the material 004; 004′ in the roller gap 104; 104′ directly or in an insertion aid possibly provided thereabove.

In a particularly advantageous embodiment, for example with respect to a defined and/or more uniform infeed into the conveyor line of the powder feed device 700; 700′, the powder feed device 700; 700′ comprises a dispensing device 701; 701′, which is designed in the form of a metering device 701; 701′ and which comprises a linear conveyor 704 as a metering unit 704, relating in particular to the conveying speed, which is preferably designed as a vibrating conveyor 704, which is or can in particular be operated electromagnetically, and by which powdered material 004; 004′ can be dispensed in a metered fashion to a conveying device 702 that follows downstream, for example a linear conveyor 702, in particular a conveyor belt 702 following downstream. The dispensing or transfer onto the conveyor belt 702 is not just carried out in a localized manner at a narrowly delimited spot, but in sections or continuously across a dispensing width that, at least in the operating position, for example, preferably corresponds exactly or at least approximately, that is, with a maximum deviation of, for example, ±10%, to the feed width that is ultimately relevant for the infeed into the nip 104; 104′. Preferably, for example for the adaptation to different product formats or for correction purposes, the dispensing width for the dispensing of the material 004; 004′ by the metering device 701 or the transfer onto the conveyor belt 704, viewed transversely to the conveying direction T_{P}, can be set, for example manually or advantageously remotely controlled by drive means, in the width and/or the lateral position. In addition, lateral boundaries 717, for example side guides 717, are provided, for example on the vibrating table 706, which can, for example, be displaced transversely to the conveying direction T_{P} manually or, in a more automated configuration, remotely controlled by drive means. As a result, no significant change to the width of the stream is required on the downstream conveying device 702, which otherwise could possibly have an interfering influence on the height profile extending in width.

In an advantageous refinement, a conveying width on the conveyor belt can, for example also for the above-described reasons, be settable in the width and/or lateral position. For this purpose, lateral boundaries 716, for example side guides 716, which can be displaced transversely to the conveying direction T_{P}, for example manually or, in a more automated configuration, remotely controlled by drive means, are provided, which can be varied in terms of the lateral position by way of a corresponding mechanism, for example a respective threaded spindle or threaded spindle sections. The dispensing width, at least in the operating position, for example preferably corresponds exactly or at least approximately, that is, with a maximum deviation of, for example, ±5%, to the feed width that is ultimately relevant and desired for the infeed into the nip 104; 104′. The dispensing and conveying widths can be adjustable in the width mechanically independently of one another, mechanically coupled with one another or coupled in terms of control.

The stream of powder of the dispensing device 701 designed or effective as a metering unit 701 or of the at least one metering unit 704; 721 can preferably be finely adjusted in such a way that a constant and/or controllable, in particular with an accuracy in the dispensed amount having a deviation of no more than 3%, in particular no more than 2% from the target dispensed amount, stream of powder mixture 004 can be dispensed to a or the subsequent downstream conveying device 702, which can in particular be operated at a constant and/or controlled speed, in particular to the conveyor belt 702, in the relevant range for the specific dispensing rate, that is, the dispensing rate based on the width.

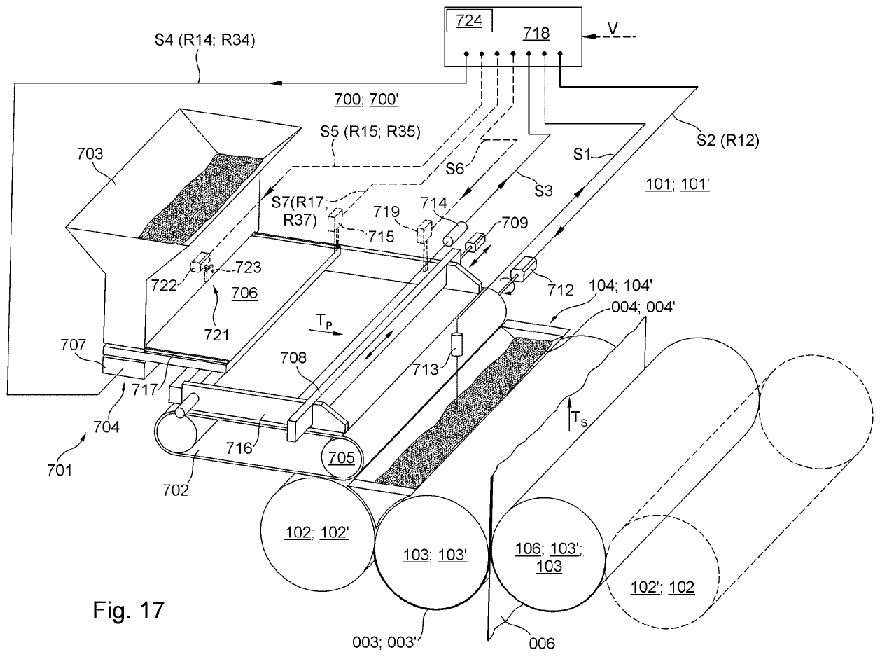

In a particularly advantageous embodiment, which, for example, is apparent in FIG. 17, for example with respect to a defined and/or more uniform transport in at least a first part of the conveyor line of the powder feed device 700; 700′, an above-described, preferably electromagnetic, linear conveyor 704, which in particular is designed as a vibrating conveyor 704, is provided as a first or only metering unit 704. This conveyor, in the width extending in the axial direction of the rollers 102, 103; 102′; 103′, extends, for example, across a dispensing width that, for example, preferably exactly or at least approximately, that is, for example, with a maximum deviation of ±5%, corresponds to the feed width that is ultimately relevant and desired for the infeed into the nip 104; 104′. The dispensing width is preferably settable. An outlet, extending in sections or continuously across an outlet width, of a provision device 703, for example of a supply line 703 or, as shown, for example, in FIG. 17, of a supply reservoir 703 via which powdered material can be dispensed to the linear conveyor 704, ends above this vibrating conveyor 704. A provision device 703 designed as a supply reservoir 703 can, for example, be formed, for example in at least the lower part, as a reservoir tapering in a funnel-shaped manner, for example, in the form of a supply hopper 703, and can be fillable, for example, manually or via a system of lines. It can advantageously comprise a fluidizing device, such as a device for blowing in a gaseous medium, in particular air. In the shown and advantageous embodiment, the metering unit 701 comprises the vibrating conveyor 704 as well as a provision device 703, which keeps material 004; 004′ available at least to a certain extent, and can form a unit that here, for example, is also referred to as a metering unit comprising a vibratory drive 701, or a metering jogger 701 for short, and that, for example, represents an assembly and can be referred to as such, which can be filled from a reservoir, for example manually or via a feed line.

The vibrating conveyor 704 comprises, for example, a vibrating table 706 and a drive means 707 driving the same, in particular a vibratory or jogging drive 707 driving the same, which is in particular electromagnetically excited, wherein the term vibratory or jogging drive 707 shall be understood to be synonymous and to mean a drive device 707 driving a jogging or vibrating device. Preferably, the vibrating frequency and/or vibrating amplitude of the vibratory or jogging drive 707 or a control unit controlling this vibratory drive 707 can be varied and/or the vibrating table 706 can be set manually or by means of a drive means 715, for example positioning drive 715, with respect to the descending gradient thereof, viewed in the conveying direction T_{P}.

In addition to the above-described metering unit 704 formed by a vibrating conveyor 704, a metering unit 721 which varies the dispensed stream at the outlet, and thus the stream transferred onto the conveying device 702, can be provided in a, for example, with respect to a particularly well-definable feed stream, and/or, for example, for pre-metering. Such a metering unit can be provided, for example, by a positioning mechanism 721, which is only schematically depicted in FIG. 17, by way of which, for example, a distance between the outlet and the upper side of the linear conveyor 704 can be varied by means of assigned drive means 722, for example, by way of one or more servo motors 722; 722.x, in conjunction with a metering unit 721 relating to the transfer level onto the conveying device 702, and/or, for example, a free flow cross-section out of or into the provision device 703 can be varied in conjunction with a metering unit 721 relating to the dispensed stream at the outlet.

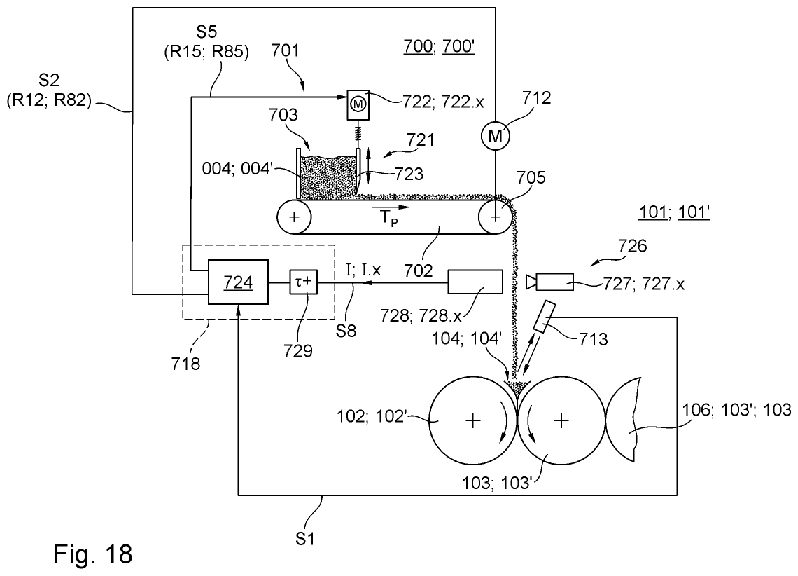

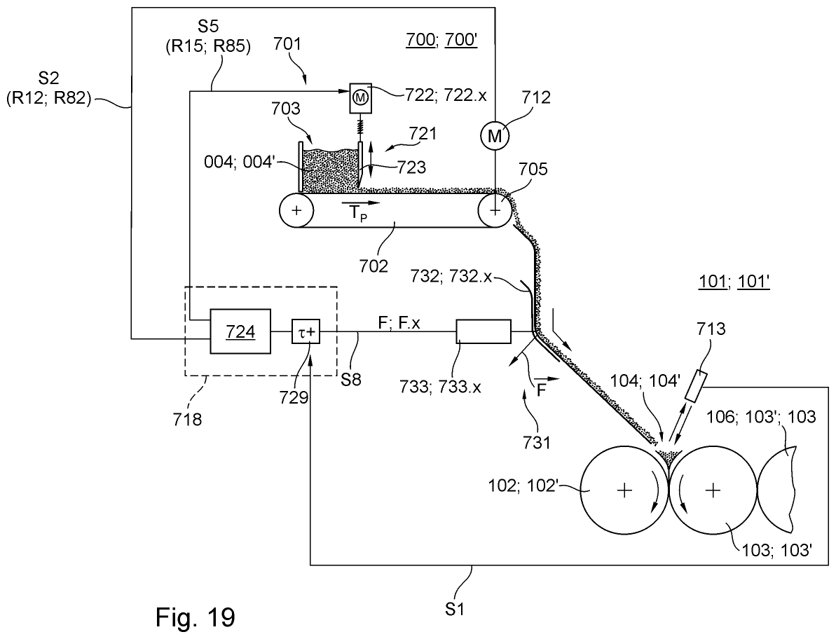

A controllable positioning mechanism 721, which varies the outlet cross-section by way of one or more assigned drive means 722; 722.x, for example one or more servo motors 722, can be assigned to or arranged upstream from the outlet of the provision device 703 as a metering unit 721 relating to the dispensed stream at the outlet. Such a positioning mechanism can comprise, as the positioner 723 which is only shown symbolically and by way of example in FIG. 17, a flap 723, which extends across the outlet width and is actuated by the drive means 722, or a slide 723, or by several positioners 723.x, which are arranged next to one another across the outlet width and are adjustable independently of one another by several drive means 722.x, such as, for example, flap or slide segments 723.x (see, for example, by way of example in FIG. 18 and FIG. 19). If several positioners 723.x that can be adjusted by drive means 722.x are present, the flow cross-section or dispensed stream can be varied and/or individually corrected across the dispensing width.

One or more assigned drive means 722; 722.x, for example, one or more servo motors 722, which vary the distance between the outlet of the provision device 703 and the upper side of the linear conveyor 704, in particular raise or lower the provision device 703 or the part comprising the outlet, via a corresponding positioning mechanism 723, for example a gear, can be provided as a metering unit 721 that is provided in addition or instead and relates to the transfer level onto the conveying device 702.

Generally independently of the embodiment of the dispensing device 701 comprising a metering unit 704 designed as a vibrating conveyor 704 and independently of the presence and/or of the embodiment of an above-described further metering unit 721, preferably, however, in conjunction with a metering unit 704 designed as a vibrating conveyor 704 and/or, for example, at least one above-described further metering unit 721, in a particularly advantageous embodiment of the powder feed device 700; 700′, for example with respect to a more uniform material stream, a removal device 708, which extends horizontally across at least the conveying width and the distance of which with respect to the upper side of the linear conveyor 704 can be set, is provided above the or a linear conveyor 702 that is arranged downstream from the dispensing device 701 in the conveying direction T_{P} between the point at which the material is fed onto the linear conveyor 702 and a point at which it is transferred to the roller gap 104; 104′ or the possibly provided insertion aid 711, or possibly to a further downstream conveying device.

Such a removal device 708 can be used to establish or implement a desired and uniform layer height of the material 004; 004′ to be conveyed on the linear conveyor 702 or conveyor belt 702 across the conveying width, assuming parallelism exists between the underside of the removal device 708 and the upper side of the linear conveyor 704 on at least the effective length. If material 004; 004′ is applied over the entire conveying width upstream from the removal device 708 in a thickness that at least corresponds to the distance between the removal device 708 and the upper side of the linear conveyor 704, a material stream having a uniform layer thickness of the powdered material 004; 004′ which is defined via the position of the removal device 708 is ensured downstream from the removal device 708.

In a particularly advantageous configuration, the removal device 708 is designed as a removal squeegee 708, which can preferably vibrate transversely to the conveying direction T_{P} and which, during operation, for example, carries out an oscillating or vibrating back-and-forth movement. For this purpose, the removal squeegee 708 is mounted, for example, so as to be axially movable and driven in an oscillating or oscillatable manner by a drive means 709, for example a drive motor 709. This drive motor 709 can be designed directly as a linear motor or as a rotatory motor driving the removal squeegee 708 via an oscillating drive. In an advantageous refinement, the removal device 708 is settable in terms of the distance with respect to the conveying device 702 by a drive means 719, which, for example, is only schematically depicted in FIG. 17, for example a positioning drive 719, for example via a signal connection S6 in a remotely controlled manner.

In an alternative configuration, a roller rotatable or rotating counter to the conveying direction T_{P} on the underside thereof, in particular a so-called roller squeegee, can be provided as the removal device 708. In a refinement, this roller can additionally be oscillatable in the above-described manner by way of corresponding drive means and a corresponding mount.

In a particularly advantageous embodiment of a powder feed device 700; 700′, which can be applied, for example, to all embodiments, designs and variants of the powder feed device 700; 700′ set out here, at least one sensor system comprising a preferably contactlessly operating sensor 713; 714 is provided, which, for example, supplies a piece of information about a vertical position of a powder layer surface and/or which, for example, is based on a contactless measuring principle, for example using sound waves or electromagnetic radiation, and/or which, together with an open-loop and/or closed-loop control device 724 connected via a signal connection S1; S3, in particular with a control logic or electronic control circuit comprised by the open-loop and/or closed-loop control device 724, and with a drive means 712; 722; 707 assigned to the or a metering or conveying device 702; 704; 721 for varying the dispensing or conveying rate, forms a control loop R11; R14; R15; R17; R34; R35; R37 via a respective signal connection S2; S4; S5; S7.

In a particularly advantageous embodiment that can be applied to all embodiments, designs and variants of the powder feed device 700; 700′ set out here, a sensor system, in particular a fill level sensor system, is provided as a sensor system that supplies a piece of information about a height of a powder layer, which is provided with a sensor 713 supplying a piece of information about the filling height in the roller gap 104; 104′ or in the insertion aid 711, a fill level sensor 713 for short, which, in particular from above, is directed into the wedge-shaped space 108 of the roller gap 104; 104′ or into the interior of an insertion aid 711 that may be provided over the roller gap 104; 104′ onto the powder layer, in particular powder layer surface, and in this way provides a piece of information corresponding to a filling height in the roller gap 104; 104 or in the insertion aid 711, at at least the point being observed.

An advantageously provided control loop R11; R14; R15; R17 comprises an above-described fill level sensor system comprising the sensor 713 for detecting a piece of information representing a fill level of powdered material 004; 004′ in the roller gap 104; 104 or in the insertion aid 711. In such a control loop R1; R1′, the sensor 713 supplying the information about the fill level in the roller gap 104; 104′ or in the insertion aid 711 is, for example, connected, in terms of signaling, to a control logic or circuit comprised by an above-described open-loop and/or closed-loop control device 724, which, in turn, has a signal connection S2; S4; S5; S7 to the control means of one or more drive means 712; 722; 715; 707 of one or more above-described conveying devices and/or metering units 702; 704; 721 for varying the conveying and/or dispensing and/or transfer rate of powdered material 004; 004′.

In an advantageous embodiment, in particular for phases of changing machine speeds, such as a starting phase, a control loop R12 relating to the conveying speed of the conveying device 702 is provided, for example, in which the fill level sensor system has a signal connection to a drive means 712 driving the conveying device 702, here, for example, the dispensing device 701 driving the conveyor belt 702, via the open-loop and/or closed-loop control device 724 or a control logic or circuit comprised thereby and accordingly configured for forming a control loop R12 relating to the conveying rate. The conveying speed is controlled by the relevant drive means 712 for this purpose, for example, based on the fill level, for example in the manner that the conveying speed is increased when a defined minimum threshold is fallen short of, and the conveying speed is decreased when a defined maximum threshold is exceeded.

Instead of the fill level-dependent variation or in addition thereto, a control correlating with a variable V representing the machine speed via a stored relationship can serve as the basis for driving the conveying device 702, by way of which the conveying device 702 is operated more quickly, for example, when the machine speed is increasing and is operated more slowly when the machine speed is decreasing. The above-described fill level-dependent regulation can serve as the basis for this control.

Instead of or in addition to an above-described control loop R12 relating to the conveying rate and/or the machine speed-dependent control of the conveying device 702, in an advantageous embodiment a control loop R15; R14; R17 relating to the dispensing device 701, in particular the dispensing rate of the dispensing device 701 onto the conveying device 702, can be provided, in which the fill level sensor system has a signal connection S4; S5; S7 to one or more of the drive means 722; 722.x; 707; 715 comprised by the dispensing device 701 for metering purposes via the open-loop and/or closed-loop control device 724 or an accordingly configured control logic or control circuit comprised thereby, for example, in a control loop R15 relating to the dispensing device 701, has a signal connection to drive means 722; 722.x of the positioning mechanism 721 arranged upstream of or assigned to the outlet and/or, in another control loop R14 relating to the dispensing device 701, has a signal connection to the vibratory drive 707 and/or, in another control loop R117 relating to the dispensing device 701, has a signal connection to the positioning drive 715 for the table slope. The described control loops R15; R14; R17 relating to the dispensing device 701 can be provided individually, in pairs or collectively, wherein, if several such control loops R15; R14; R17 are provided, preferably a cascading or prioritization of individual control algorithms is provided.

An underlying regulation of the dispensing device 701 for the fill level sensor system, in particular of the control loop R15; R14; R17 or of the control loops R15; R14; R17 relating to the dispensing rate of the dispensing device 701 onto the conveying device 702 by the relevant driving means 722; 722.x; 707; 715 for this purpose takes place, for example, based on the fill level, for example in the manner that the dispensing rate is increased when a defined minimum threshold for the fill level is fallen short of, and the dispensing rate is decreased when a defined maximum threshold is exceeded.

Instead of the fill level-dependent variation of the dispensing rate or preferably in addition thereto, a control correlating with a variable V representing the machine speed can serve as the basis for the metering by the metering unit 701, by which the metering unit 701 or one or more metering units 704; 721 comprised thereby, for example, increases the dispensing rate by the metering unit 701 or one or more metering devices comprised by the metering unit 701, for example when the machine speed is increasing, by appropriately activating one or more of the above-described drive means 722; 722.x; 707; 715 and lowers the dispensing rate when the machine speed is decreasing. This control can correlate with the above-described machine speed-dependent control of the conveying device 702 and/or can serve as a basis for the above-described fill level-dependent control of the dispensing device 701.

In a refinement of the embodiment comprising the removal device 708, the feed rate can additionally also be varied, for example pre-set, by varying the distance of the removal device 708 via an assigned drive means 719, manually or remotely controlled via a signal connection S6 or possibly a control loop (R16) which is not explicitly set out here.

Generally independently of, but advantageously in conjunction with an above-described fill level sensor system and/or one or more above-described control loops R12; R14; R15; R17 (R16) forming the basis for the fill level, in an embodiment, which in particular comprises a linear conveyor 702, for example, a sensor system supplying a piece of information about the vertical level of the powder layer surface on the conveying device 702, a layer level sensor system for short, is provided as an alternative or further sensor system supplying pieces of information about the vertical position of a powder layer surface. This sensor system comprises a sensor 714 that supplies a piece of information about the layer height or at least the level of the powder layer surface on the conveying device 702 and preferably operates contactlessly, for example a level sensor 714, which, for example, is directed, for example as an optical or ultrasonic sensor, from one side at the profile of the powder layer and supplies at least one piece of information about the vertical position of at least a highest elevation of the powder layer across the conveying width transversely to the conveying direction T_{P}. In the case of a stable vertical position of the conveying device 702 during normal operation here, the level of the powder layer surface denotes a resulting powder layer thickness.

In a simple case, the sensor 714, for example, only monitors when a certain level of a highest elevation is exceeded or fallen short of, and the result is used for control purposes, for example. The process of simply monitoring a certain height for when it is exceeded or fallen short of can be implemented, for example, by a single-beam photoelectric sensor or a linearly operating ultrasonic sensor. In a more complex embodiment, which, however, results in more extensive information, it is also possible for the sensor system to provide a piece of information about the vertical position of a highest elevation that is currently present across the conveying width, at least in a certain range. For example, a sensor system extending in the vertical direction over a certain height, such as a light barrier or an ultrasonic sensor with vertical resolution, can be used.

Generally independently of, but advantageously in conjunction with one or more above-described control loops R12; R15; R14 or R17 forming the basis for the fill level and/or an above-described speed-dependent control, a control loop R35; R34; R37, for example, which comprises an above-described layer level sensor system comprising an above-described layer level sensor 714, is provided in an advantageous embodiment of a device comprising the removal device 708. This is connected, in terms of signaling, in such a control loop R35; R34; R37 to a control logic or control circuit comprised by an above-described open-loop and/or closed-loop control device 724 which, in turn, has a signal connection to the control means of one or more drive devices 707; 722; 715 of one or more above-described metering units 704; 721 for varying the dispensing rate of the metering device 701. A control of the metering device 701 with respect to the dispensing rate or of a metering unit 704; 721 comprised thereby by the relevant drive device 707; 722; 715 is carried out, for example, based on the level, that is, as a function of the information supplied by the layer level sensor system, for example in the manner that the dispensing rate dispensed by the dispensing device 701 or transferred onto the conveying device 702 is increased when a defined minimum threshold for the level of the surface or a target value is fallen short of, for example by more than a permissible tolerance, and the dispensing rate is decreased when a defined maximum threshold or the target value is exceeded, for example by more than a permissible tolerance, by way of at least one control loop R35; R34; R37 comprising the layer level sensor 714.

Instead of or in addition to an above-described control loop R12 relating to the conveying rate and/or the machine speed-dependent control of the conveying device 702 and/or a control loop R15; R14; R17 relating to the dispensing device 701, in particular the dispensing rate of the dispensing device 701 onto the conveying device 702 based on the fill level, in an advantageous embodiment a control loop R35; R34; R37 relating to the dispensing device 701, in particular the dispensing rate of the dispensing device 701 onto the conveying device 702 based on the layer level, can be provided, in which the layer level sensor system has a signal connection to one or more drive means 722; 722.x; 707; 715 comprised by the dispensing device 701 for metering purposes by way of the open-loop and/or closed-loop control device 724 or a control logic or control circuit comprised thereby and accordingly configured, for example in a control loop R35 relating to the dispensing device 701 has a signal connection to a drive means 722; 722.x of the positioning mechanism 721 arranged upstream of or assigned to the outlet and/or in another control loop R34 relating to the dispensing device 701 has a signal connection to the vibratory drive 707 and/or in another control loop R37 relating to the dispensing device 701 has a signal connection to the positioning drive 715 for the table slope. The described control loops R35; R34; R37 relating to the dispensing device 701 can be provided individually, in pairs or collectively, wherein, if several such control loops R35; R34; R37 are provided, preferably a cascading or prioritization of individual control algorithms is provided.

A powder feed device 700; 700′ comprising a metering device 701, in particular a metering device 701 comprising a metering unit with a vibratory drive 707, and a downstream conveying device 702, in particular a linear conveyor 702, is advantageously operated as follows:

The dispensing device 701, which is in particular designed as a metering device 701, is initially and during operation filled as needed with powdered material 004; 004′ to be processed, and the material is dispensed from the metering device 701 in a metered fashion to the conveying device 702, in particular by jogging. In a particularly advantageous refinement, using an above-described removal device 708, slightly more, for example up to 10%, preferably only up to 5% more material 004; 004′ is dispensed to the conveying device 702 than is in fact removed, which is then removed or held back to a certain, in particular settable height, by way of the preferably oscillating removal device for providing a uniform material layer. The dispensing rate of the dispensing device 701 to the conveying device 702 can be controlled, for example, by way of an above-described control loop R35; R34; R37 comprising the level sensor 14 at the conveying device 702, for example in such a way that the detected level always corresponds at least to the set distance in relation to the conveying device 702, advantageously even exceeds it.

The powdered material 004; 004′ conveyed on the conveying device 702 and preferably guided through beneath the removal device 708 in the above-described manner is conveyed by the conveying device 702 into the gap 104; 104′ or an insertion aid 711 possibly provided thereabove directly or possibly via a further conveying device.

In an advantageous embodiment, the conveying device 702 and possibly a following further conveying device can be controlled in the above-described manner by way of an above-described control loop R12 comprising a fill level sensor 713, which monitors the fill level in the gap 004; 004′ or in the insertion aid 711.

In an advantageous refinement, the dispensing width of the dispensing device 701 and/or the conveying width of the conveying device 702 is set manually or preferably remotely controlled via corresponding drive means for a format change in the product 001; 002 to be produced.

So as to vary a maximum material supply, for example, beyond a metering by the dispensing device 701 or as an alternative thereto, the distance between the removal device 708 and the conveying device 702 can be varied in an advantageous embodiment.

For the above-described embodiments and variant embodiments of the powder feed device 700 (for example, in conjunction with FIG. 17) as well as in particular also for embodiments and variant embodiments deviating therefrom, which are set out, for example, in conjunction with FIG. 18 and FIG. 19, for the implementation of the dispensing or metering device 701, generally independently of the above-described sensor systems, sensors 713; 714 or control loops R12; R14; R15; R17; R34; R35; R37, but advantageously in conjunction with one or more of the above-described sensor systems, sensors 713; 714 or control loops R12; R14; R15; R17; R34; R35; R37, a sensor system 726; 731, for example powder stream sensor system 726; 731, comprising, for example, a sensor 728; 733 by which a piece of information about the powder stream, in particular about the magnitude and/or homogeneity, can be made available, is provided which, at at least one point or preferably over the entire width, in particular drop width, is directed continuously or at multiple points in a localized manner or in sections at a stream of powder that emerges from the powder feed device 700 and is fed into the roller gap 104; 104′ or into the insertion aid 711 possibly arranged thereabove, in particular in a drop section between the or a last conveying device 702 comprised by the powder feed device 700; 700′ and the roller gap 104; 104″ or a possibly provided insertion aid 711. Such a sensor system 726; 731 or information obtained therefrom can, in a first specific embodiment, supply a variable I; F obtained integrally, that is, in sum over the considered width, for example the entire width or continuous width over a section or width that is interrupted in sections, in particular the drop width of the powder stream, for example measured variable I; F, or can, in a second specific embodiment, preferably supply individual values of such a variable I.x; F.x which are spatially resolved in terms of the width.

In a first specific embodiment, a piece of information about the powder stream in the considered region can be obtained via an integral value of the variable I; F, which in the case that the detection does not occur across the entire width can be used, as a first approximation, as a measure for the entire stream. In this way, it is possible for a powder stream, for example, to be guided, for example be kept at a constant level, in a control loop R82; R85, which is explained below, for example, or, for example when, for example, empirically ascertained relationships between the ascertained variable I; F and the magnitude of the throughput are present, the stream of powder can be controlled by open loop or closed loop control in terms of the throughput thereof.

In an advantageous embodiment of this first specific embodiment, a control loop R82; R85 is provided, which comprises an above-described integral powder stream sensor system 726; 731 comprising an above-described sensor 728; 733. The same is connected in such a control loop R82; R85 via a signal connection S8 to a control logic or control circuit comprised by an above-described open-loop and/or closed-loop control device 724, which, in turn, is connected via a signal connection S2; S5; S7 to the control means of one or more drive means 712; 707; 722; 715 of one or more above-described conveying devices or metering units 704; 721 for varying the conveying rate of the conveying device and/or the dispensing rate of the metering device 701. The relevant control logic or control circuit has a signal connection S2; S5, for example, in a control loop R82 relating to the conveying rate via to the drive means 712 driving the conveying device 702 and/or in a control loop R85 relating to the dispensing device 701 to a drive means 722; 722.x of the positioning mechanism 721 arranged upstream from or assigned to the outlet. For a variant embodiment comprising a dispensing device comprising an above-described vibrating conveyor 704, a control logic or control circuit of the open-loop and/or closed-loop control device 724, which is connected, in terms of signaling, to a sensor 728; 733 of the powder stream sensor system 726; 731, can be connected to the vibratory drive 707 in another control loop (not shown) relating to the dispensing device 701 and/or can be connected to the positioning drive 715 for the table slope in a further control loop (not shown) relating to the dispensing device 701. The described control loops R82; R85 relating to the dispensing device 701 and/or the conveying device 702 can be provided individually, as several or collectively, wherein, if several such control loops R82; R85 are provided, preferably a cascading or prioritization of individual control algorithms is provided.

In a second specific embodiment comprising a sensor system 726; 731 which is provided at multiple points in a localized manner or in sections, respective pieces of information about the powder stream in the relevant section or at the relevant measurement site can be obtained across the width by individual, spatially resolved values of an above-described variable I.x; P.x for each individual section or measurement site, which each represent a measure of the powder stream in the relevant section or at the relevant measurement site. In this way, it is likewise possible for a total powder stream to be guided, for example to be kept at a constant level, in a control loop R82; R85, which, for example, is explained above, for example after the sum or mean value has been determined, or, for example when, for example, empirically ascertained relationships between the ascertained variable I; F and the magnitude of the throughput are present, the powder stream can be controlled by open loop or closed loop control in terms of the throughput thereof. Instead of or in addition to this integral assessment and a control based thereon, however, a powder stream can be controlled by open loop or closed loop control for several or all sections or measurement sites in respective control loops R82; R85, at least relative to partial powder streams in other sections or at other measurement sites or, for example, when empirically ascertained relationships between the ascertained variable I.x; F.x and the magnitude of the throughput are present, the relevant powder stream, in particular partial powder stream, can be controlled by open loop or closed loop control in terms of the throughput.

In an advantageous embodiment of this second specific embodiment, a respective control loop R82; R85 is provided for several or all sections or measurement sites with a dedicated, above-described sensor 728.x; 733.x. This sensor 728.x; 733.x is connected, in terms of signaling, in such a control loop R82; R85 to a control logic or control circuit comprised by an above-described open-loop and/or closed-loop control device 724, which, in turn, has a signal connection to control means of several drive means 722.x of a metering unit 721 that can be adjusted in the width in sections or segments so as to vary the dispensing rate from the metering device 701 in sections. Sections or measurement sites comprising dedicated sensors 728.x; 733.x correspond to sections or segments, in particular positioner segments 723.x, of a metering unit 721 that can be adjusted in sections, for example with above-described positioner segments 723.x driven by drive means 722.x, for example flap or slide segments 723.x. A control of the individual positioners 723.x or positioner segments 723.x is carried out in such a way, for example, that an equally large powder stream, for example, is detected by the sensor system 726; 731 in all considered sections. If needed, the control can also be directed at a desired profile, that is, with powder streams in the considered sections which differ across the width.

In an advantageous embodiment (see, for example, FIG. 18 and FIG. 19), the powder feed device 700; 700′, as was already set out, for example, above with respect to FIG. 17, comprises a conveying device 702, by which powdered material 004; 004′ is conveyed over a conveying width and from there is fed to a roller gap 104; 104′ located therebeneath or a possibly provided feed aid 711. The feeding itself in particular occurs by the powder stream dropping over a drop path, after the end of the or a last conveying device 702 has been reached, into the roller gap 104; 104′ or the insertion aid 711.

In a particularly advantageous embodiment of a powder feed device 700; 700′ in one of the embodiments or variants set out above or set out below, the above-described powder stream sensor system 726; 731 is provided in the region of the drop path between the only or downstream last conveying device 701 of the powder feed device 700; 700′ and the roller gap 104; 104′ or the possibly provided insertion aid 711.

Such a powder stream sensor system 726; 731 is shown, for example, in conjunction with an advantageous embodiment of the dispensing device 701 according to FIG. 18 and FIG. 19, wherein the same reference numerals as those used before in FIG. 17 are used for functionally comparable or identical parts. In contrast to the specific embodiment shown based on FIG. 17, the dispensing device 701 here is shown without a vibrating conveyor 704, but instead with a metering unit 721, which is only schematically depicted in FIG. 17, for example, and relates to the dispensed stream at the outlet of the provision device 703 and by way of which, for example, the free flow cross-section in the provision device 703 or out of the same can be varied. What was described with respect to the powder stream sensor system 726; 731, however, can also be applied to an above-described embodiment comprising a vibrating conveyor 704 or any other specific embodiment in which the stream of powder is or can be fed from the conveying device 702 over a drop section to the roller gap 104; 104′ or an insertion aid 711 possibly provided thereabove.

In conjunction with the above-described control loop R85 comprising the powder stream sensor system 726; 731 based on an integral value for the variable I; F, the metering unit 721 can be designed with a positioner 723; 723.x which is continuous across the width or segmented, wherein for the latter case, for example, an identical adjustment of the positioners 723.x takes place when controlled via a single integral value of the variable I; F. If an insufficient powder stream or an undesirable decrease in the powder stream is determined based on the information provided via the variable I; F, the continuous positioner 723 is or the positioner segments 723.x are opened wider for greater material through-put, and vice versa. It is also possible for a certain throughput to be controlled when an above-described relationship exists.

As an alternative or in addition, it is also possible to control the speed of the conveying device in a control loop R82 based on the integral value for the variable I; F by appropriately activating the drive means 712.

In conjunction with the above-described control loop R85 comprising the powder stream sensor system 726; 731 of a control in individual sections based on individual values for such a variable I.x; P.x, the metering unit 721 comprises positioners 723.x formed in sections by positioner segments 723.x. The positioner segments 723.x or the positioning drives 722.x thereof are, for example, adjusted via respective control loops R82; R85 corresponding to the specified control task, based on respective individual values for the variables I.x; P.x at the relevant sections or measurement sites. It is possible, for example, to set a profile that is uniform across the width or possibly a specified profile having powder streams that differ across the width. When an above-described relationship is present, it is also possible to set a profile having a throughput that is uniform or varies across the width. One or more further circuit elements 729, such as a dead-time element 729, can be provided in the particular control loop R82; R85.

In a first advantageous embodiment of the powder stream sensor system 726 (see, for example, FIG. 18), it is based on a measurement using electromagnetic radiation, in particular light in the UV, IR or visible wavelength range, in particular in the form of a photoelectric sensor 726. For this purpose, a radiation source 727, for example a light source 727, is provided, for example, on one side of the drop path, and a sensor 728; 728.x, in particular a radiation receiver 728; 728.x, is provided on the other side. A radiation intensity I; I. x that is recorded at the sensor 728 is used here as the variable I; I.x supplying information about the powder stream. For the case of an integral determination and evaluation within the above meaning by means of only one value for the variable I, a single radiation source 727, for example, in particular a directed light source 727, and/or a single radiation receiver 728, for example a photodiode 728 or a phototransistor 728, can be provided. For the second case, which allows a control in individual sections based on individual values for such a variable I.x; P.x, an extended radiation or light source 727.x, for example in the form of a light barrier 726, a plurality of individual light sources 727.x or a light bar 727.x, and a plurality of radiation receivers 728.x, an extended, in particular spatially resolving radiation receiver 728.x or radiation receiver segments 728.x, such as a radiation receiver array 728.x, a photodiode array 728.x or a line camera 728.x, can be provided. By detecting the radiation intensity I; I.x, the constancy of a mass flow can be checked, and when, for example, an empirically ascertained relationship is present, the powder stream can even be controlled by open loop or closed loop control in terms of the throughput thereof, in sections or integrally depending on the design.

In a second advantageous embodiment of the powder stream sensor system 731 (see, for example, FIG. 19), it is based on the use of a force measurement, in particular on a measurement of the force acting on a sensor 733; 733.x designed as a force transducer 733; 733.x due to the impulse of the falling powder particles. A value for a force F; F.x recorded at the sensor 733; 733.x. is used here as the variable F; F.x supplying information about the powder stream. If an integral determination and assessment within the above meaning by means of value for the variable I is carried out, a single force transducer 733 can be provided, on which the powder stream acts over the entire width or a sub-section representative of the width. For the second case of a control in individual sections based on individual values for such a variable F.x, a plurality of individual force transducers 733.x, for example in the form of a, for example piezoelectrically operating, force transducer array 733.x, can be provided.

The action on the force transducer or force transducers 733; 733.x can generally be arbitrarily implemented in such a way that an impulse of the material 004; 004′ dropping across the width or a sub-section in the powder stream is transmitted to the relevant force transducer 733; 733.x. In the advantageous embodiment shown here, a deflecting element 732; 732.x, for example a deflecting plate 732; 732.x, which is situated in the drop path of the section to be considered and is functionally connected to an assigned force transducer 733; 733.x; is provided for the or each section to be considered, that is, over the entire width, a representative sub-section or several individual sub-sections. The deflecting plate 732; 732.x can be designed in the form of a diverting panel 732; 732.x so that, even though an impulse can be transmitted, the material 004; 004′ does not continue to flow to the roller gap 104; 104′ or an insertion aid 711 provided thereabove. The deflecting element 732; 732.x can be pivotably or elastically mounted and/or supported against the force transducer 733; 733.x, so that the powder stream increases the force F; F.x recorded by the force transducer 733; 733.x, for example when the load from the powder stream grows. The measuring principle is based on an impact with a change in direction, wherein the physical relationship F=m×a (force=mass×acceleration) and the change in direction during the impact form the basis for a resulting force F. By detecting the force F, the constancy of a mass flow can be checked, and when, for example, an empirically ascertained relationship is present, the powder stream can even be controlled by open loop or closed loop control in terms of the throughput thereof.

In a further embodiment of a powder feed device 700; 700′ that is advantageous, for example, with respect to a more uniform supply over the metering gap 104; 104′ and/or in the filling and/or supply chamber 126, the powdered material 004; 004′ can be provided via a dispensing device 701 designed, for example, as a metering device 701, in particular a metering unit 701 comprising a vibratory drive 707, such as, for example, a metering jogger 701, and be dispensed or fed, preferably directly at the downstream-side end of the metering jogger 701 or of the jogging table comprised thereby or optionally indirectly via one or more additional downstream conveying devices 701, into the roller gap 104; 104′ or into the filling and/or supply chamber 126 provided thereabove. The dispensed amount of the metering jogger 701 can preferably be controlled, for example in an above-described manner, by way of a fill level sensor system and/or the dispensing or feeding width can be set to a desired format width.

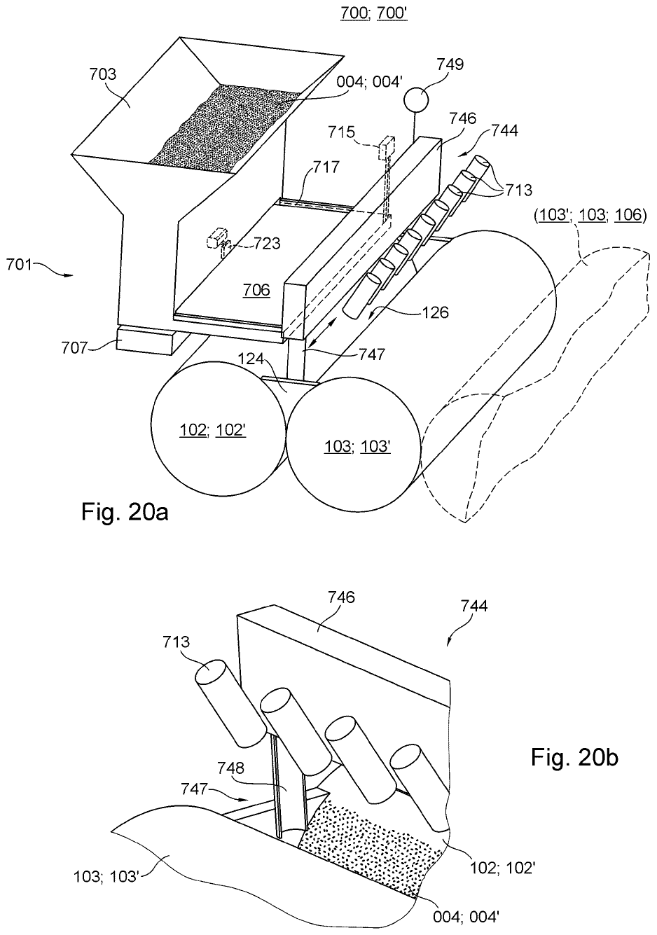

Above the roller gap 104; 104′, a distribution device 744 is provided in this embodiment, by which, for example, a fill level in the filling and/or supply chamber 126, which is preferably adjustable in terms of the width and/or axial position, can be made more uniform across the width thereof in the axial direction of the rollers 102; 103; 102′; 103′ (see, for example, FIG. 20a and FIG. 20b). For this purpose, the distribution device 744 preferably comprises a, for example one-piece or multi-piece, crossbar 746, which extends, for example, axially across at least the maximum inside width of the filling and/or supply chamber 126 and on or in which a distribution tool 747, for example a one-piece or multi-piece distributor finger 747, protrudes into the filling and/or supply chamber 126 and can oscillate back and forth, or during operation moves back and forth in an oscillating manner, between an end or a region close to the end, that is, for example located no more than 10% away from the width of the filling and/or supply chamber 126, on a first end face delimiting the filling and/or supply chamber 126, and the end or a region close to the end of the opposite second end face, for example by way of an accordingly equipped drive device. In the process, the distribution tool 747 can generally be movable back and forth between the end positions along an arbitrary movement path having at least one, in particular predominant (that is, larger compared to other directions), movement component in the direction of the width of the filling and/or supply chamber 126. Preferably, it can be moved back and forth along a movement path extending parallel to the gap 104; 104′.

The drive device can comprise, for example, an electric drive motor as the drive means 749, by which a belt of a belt drive carrying the distribution tool 747 along or a thread of a threaded drive conveying the distribution tool 747 is, for example, reversibly driven or drivable. As an alternative, the drive means can comprise a pneumatic drive means 749, for example a piston to which compressed air can be applied on two sides and which is alternately acted on on the sides and carries the distribution tool 747.

The distributor finger 747 can essentially have any design so as to extend at least partly into the powder supply and displaces a portion of the powdered material 004; 004′ present in the movement path when moving back and forth. In an advantageous embodiment, the distributor finger 747, on a side pointing in the direction of movement, is designed, at least on a portion of the height thereof reaching into the powder supply, with a recess 748, for example a spoon-shaped or trough-shaped profile, for example in the form of a half shell having a, for example, vertically extending trough 748. A refinement may be advantageous, in which the distributor finger 747 is mounted and/or driven in a forcibly guided manner so that it is automatically rotated 180° at the particular turning point of the oscillating movement, so as to point with the side having the recess in the direction of movement again. This allows powdered material 004; 004′ to be prevented from accumulating in the end regions. As an alternative, a distributor finger 747 having a passage can also be provided, which allows excess material 004; 004′ to flow back, for example, during the movement.

In an advantageous refinement, a filling height level of the powdered material 004; 004′ in the filling and/or supply chamber 126 which was made more uniform by the distribution device 744 or the distribution tool 747 moving in an oscillating manner can be settable or controllable. For this purpose, for example, at least one fill level sensor 713, which was already mentioned above, is provided, which at one point of the filling and/or supply chamber 126 is directed at the upper side of the powder supply present in the filling and/or supply chamber 126. Viewed across the width of the filling and/or supply chamber 126, preferably multiple, for example at least three, advantageously at least five, in particular, for example, nine such fill level sensors 713 that are directed at the powder supply are provided. As an alternative, a differently designed sensor system, which, however, detects the feeding and/or the fill level, can be provided. The fill level sensor or sensors 713 or one or more sensors of an alternative fill level sensor system is or are connected in an above-described manner, for example, via corresponding signal connections S1; S3; S2; S4, and an above-described open-loop and/or closed-loop control device 724, in particular a control logic or electronic control circuit comprised by the open-loop and/or closed-loop control device 724, for example forming a corresponding control loop R12; R14; R15; R17; R34; R35; R37, to a drive means 722; 707 (712), which is assigned to the or a metering or conveying device 702; 704; 721 for varying the dispensing or conveying rate. With this, a desired filling height that is made uniform across the width and defined, for example, by way of a target value, can be provided.

Preferably, the dispensing width of the metering device 701 or the feed width into the roller gap 104; 104′ or into the filling and/or supply chamber 126 can be varied, for example in the manner that was already described above with respect to FIG. 17. In addition or instead, the width of the filling and/or dispensing chamber 126 and/or the stroke, that is, the width and/or position of the movement path for the distribution tool 747 and/or the vertical position, to be assumed for operation, of the part thereof that is effective for distribution and/or the oscillating frequency thereof can be settable in the above-described manner.

The powder feed device 700; 700′ can preferably comprise only one metering device 701, at the exit of which the powdered material 104; 104′ is dispensed or fed into the roller gap 104; 104′ or into the filling and/or supply chamber 126. Such a metering device 701 can advantageously be designed in an embodiment of the metering jogger 701, such as is an integral part of the powder feed device 700; 700′ in FIG. 17, FIG. 18 or FIG. 19. In one variant, corresponding to the powder feed device 700; 700′ in FIG. 17, at least one further conveying device 702 can be provided, by way of which the powdered material 004; 004′ is dispensed or fed into the roller gap 104; 104′ or into the filling and/or supply chamber 126. In an advantageous embodiment, what was set out in connection with the embodiment from FIG. 17, for example, shall be applied to the metering device 701 and/or to the provision device 703 and/or to the metering device 704 and/or to possibly an additionally provided conveying device 702.

As an alternative, the powder feed device 700; 700′, as set out, for example, in connection with FIG. 18 or FIG. 19, can comprise an above-described conveying device 702 in the form of a linear conveyor 702, which receives the powdered material 004; 004′ directly from a supply reservoir 703, that is, without an interconnected metering jogger 701, and dispenses or feeds it, possibly via a further conveying device, into the roller gap 104; 104′ or into the filling and/or supply chamber 126.

In an alternative advantageous embodiment of a powder feed device 700; 700′, for example with respect to a more uniform filling height in the supply over the metering gap 104; 104′ and/or in the filling and/or supply chamber 126, the powdered material 004; 004′ can be provided via a dispensing device 701, in particular a dispensing device 701 comprising a, for example, trough-like or vat-like, receptacle 751 that can be caused to vibrate by a drive device 707, for example a vibratory or jogging drive 707, for example also referred to here as jogging vat 751, and can preferably be dispensed or fed via one or more openings 752 in the bottom 753 of the receptacle 751 directly (see, for example, FIG. 21), or possibly indirectly via a further conveying device 702 arranged therebeneath, for example designed as a linear conveyor 702, into the roller gap 104; 104′ or into the filling and/or supply chamber 126 provided thereabove. The terms vibratory drive and jogging drive 707 are used synonymously here, without distinction, for a drive device 707 by which the jogging receptacle 751 can be operated in the function thereof. In contrast to a merely hopper-like receptacle comprising a vibratory drive, the vibrating receptacle 751 present here is used to substantially horizontally convey the material 004; 004 between an entry-side depositing process, for example from a supply reservoir 703, and exit-side dispensing process, located spaced apart in the horizontal direction, for example through the opening 752.

The receptacle 751 or the jogging vat 751 comprises an in particular circumferential wall. The fill level in the jogging vat 751 can be monitored, for example, by a fill level sensor 754, for example across a continuous range or for a minimum and/or maximum filling height, and can, for example, be controlled so as to set a certain level or to at least remain within a permitted range, for example by way of two-step or three-step control. This can take place, for example, by varying the constant supply from the supply reservoir 703 described below. In particular, the fill level sensor 754 is arranged above the bottom 753. In general, the powdered material 104; 104′ can be dispensed directly from the at least one bottom-side opening 752 into the filling and/or supply chamber 126 in the wedge-shaped space 108 over the roller gap 104; 104′. Preferably, a feed channel 756, for example also referred to as a filling neck 756 or filling chute 756, adjoins the relevant opening 752, which on the outflow-side is preferably immersed with an outlet into the wedge-shaped space 108 or filling and/or supply chamber 126 formed over the roller gap 104; 104′, that is, into the triangular or wedge-shaped space 108 between the outer cylindrical surface. The feed channel 756 or filling neck 756 or filling chute 756 can essentially have any cross-section and/or a cross-sectional profile that varies in terms of the height, but in an advantageous embodiment is formed by a, in particular vertically extending, pipe 756 having a, for example, round or rectangular cross-section, in particular a constant cross-section at least over the maximum filling height intended during normal operation. The fill level sensor 754 is preferably arranged over the at least or exactly one opening 752. In this way, it is possible to monitor and/or ascertain both the level of a filling height extending into the receptacle 751 and a filling height in the feed channel 756 if the feed channel 756 is not completely filled.

In a particularly advantageous embodiment, the fill level sensor 754 that is provided is a, preferably contactlessly operating, sensor 751, which is based, for example, on a contactless measuring principle, for example using sound waves or electromagnetic radiation. For example, it contactlessly scans the powder surface in the observed region or at the observed point, in particular using electromagnetic radiation or preferably using sound waves, wherein the radiation or sound waves directed by a radiation or sound source at the surface and reflected there are received by a radiation or sound receiver and processed into corresponding signals representing information about the filling height.

In an advantageous embodiment (see, for example, FIG. 21), the fill level sensor 754 is arranged over the opening 752 and/or at least in such a way that the same can monitor a fill level in or over the feed channel 756, that is, in the event of a back-up all the way into the receptacle, the fill level over the feed channel 756, and in the event of a not completely filled feed channel 756, the fill level in the feed channel 756 or in the drop path thereof for the material 004; 004′.

In another embodiment, which is not shown here, the fill level sensor 754 can be arranged over the sheet 753 so as to supply information about the fill level of the material 004; 004′ resting on or accumulated in a region that is adjacent to the opening 752, spaced, for example, no more than 20 mm apart from the opening 753, in particular in a region, viewed in the flow direction of the material 004; 004′, directly in front of the opening 752 leading into the feed channel 756, in the bottom 753 of the vibrating receptacle 751.

In an advantageous embodiment, the fill level sensor 754 or the sensor system comprising the same can with an open-loop and/or closed-loop control device connected via a signal connection, in particular with a control logic or electronic control circuit comprised by the open-loop and/or closed-loop control device, and with a drive means 707, by which the conveying rate of the dispensing device 701 can be varied, for example the vibratory drive 707, and/or the drive means which is not shown, by which a vertical position of the outlet 757 out of the supply reservoir 703 can be adjusted, via a respective signal connection a corresponding control loop or multiple, for example combined, in particular cascaded, control loops.

The sensor system can comprise one or preferably multiple fill level sensors 754 axially next to one another, for example at least three, for example three to nine, fill level sensors 754. The measurement results thereof can possibly be processed into a shared measurement value underlying the control process using specified rules.

In one specific embodiment, an opening 752 extending across the feed width and/or a filling neck 756 extending across the feed width can be provided. In an advantageous specific embodiment, viewed in the direction of the roller gap 104; 104′, multiple openings 752 and/or assigned feed channels 756 are provided next to one another in, for example, an above-described embodiment, having a, for example, round or rectangular.

The jogging vat 751 receives the powdered material 004; 004′ from a supply reservoir 703, for example in the form of a supply hopper 703, which in the region of the lower end thereof has an outlet 757 having one or more openings. The outlet 757 is located at the height above the bottom 753 so that material 004; 004′ can exit into the jogging vat 751, but preferably below the level of the maximum possible filling height determined by the wall of the jogging vat 751. The circumferential wall of the jogging vat 751 thus has an accordingly large height, for example more than 10 mm, in particular at least 50 mm, so that sufficient material 104; 104′ can slide in from the supply reservoir 703 and be stored in a sufficiently high filling height in the jogging vat 751. During operation, the outlet 757 is preferably immersed into the powder layer stored in the jogging vat 751, that is, is located at the level below the present filling height.

The fill level in the supply reservoir 703 can be monitored, for example, by a fill level sensor 759, for example across a continuous range or, for example, by way of two-step or three-step control, with respect to a minimum and/or maximum filling height. In this way, for example, a filling height, and thus the pressure acting on the outlet 757, can be maintained within a desired range.

The supply reservoir 703 or the outlet 757 thereof is preferably arranged so as to be spaced apart from the opening 752 or plurality of openings 752, viewed in the horizontal direction. This ensures a cross flow of material 004; 004′ stored within the receptacle 751. For this purpose, the supply receptacle 703 or the outlet 757 thereof is preferably spaced apart from the opening 752 or plurality of openings 752, in a direction located horizontally and vertically with respect to the progression of the roller gap 104; 104′. This forms a horizontal transport segment, on which the material 004; 004′ sliding in from the supply reservoir 703 can be made more uniform in terms of the filling height by way of jogging. In one refinement, guides 758 which are only hinted at with dotted lines, for example longitudinal flanges 758, can be provided in the jogging vat 751, which extend, for example, in a direction from the outlet 757 to the opening 752 or plurality of openings 752. This serves to avoid or reduce the mutual influencing of possibly different mass flows through multiple openings 752 or sections of a continuous opening 752, for example.

So as to be able to influence the filling level in the jogging vat 751, a drive mechanism, which is not shown, is provided, for example, by which the supply reservoir 703 or the outlet 757 comprised by the supply reservoir 703 can be varied in terms of the distance with respect to the bottom 753 of the jogging vat 751.

When the jogging vat 751 is active or the vibratory or jogging drive 707 is activated, the jogging vat 751 or the receptacle 751 is filled, and one or more filling necks 756 is or are filled downstream via one or more openings 752, which in turn fill the roller gap 104; 104′ or the filling and/or supply chamber 126 formed in the wedge-shaped space 108. Once the filling height in the roller gap 104; 104′ reaches the level of the outlet opening or outlet openings of the filling neck or filling necks 756, a back-up occurs in the feed channel 756, for example due to the limited flowability and/or friction present in the material layer, so that the roller gap 104; 104′ or the filling and/or supply chamber 126 formed in the wedge-shaped space 108 is not overfilled. The receptacle 751 or the jogging vat 751 is also backed up until, for example due to the limited flowability and/or friction present in the material layer, it is no longer possible for replenishing from the supply reservoir 703 to occur, even when the jogging vat 751 is being continuously operated. When the fill level in the roller gap 104; 104′ or in the filling and/or supply chamber 126 drops due to material consumption, powdered material 004; 004′ slides in. This also takes place when the material consumption differs across the width, wherein in a continuous filling neck 756 the level then becomes equalized by material sliding in, and in the case of multiple filling necks 756 the consumed powdered material 004; 004′ slides in individually across the width.

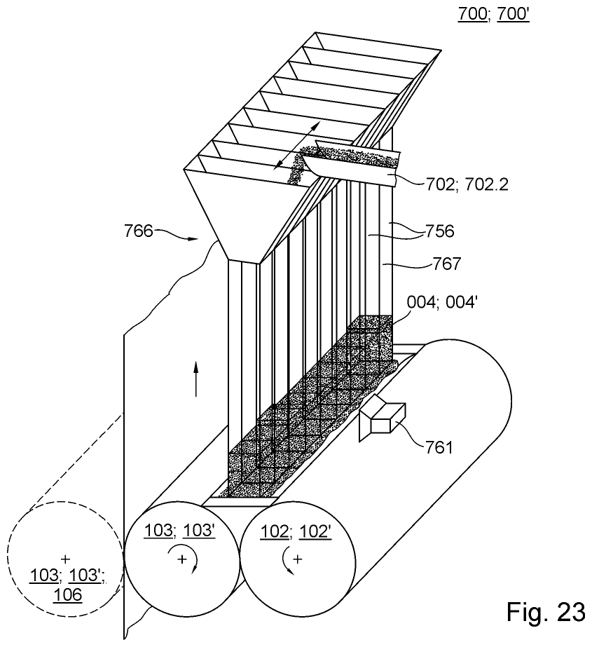

In further alternative embodiments of a powder feed device 700; 700′ (see, for example, FIG. 22 and FIG. 23), the powdered material 004; 004′, viewed with respect to a direction parallel to the roller gap 104; 104′, can be fed in sections, for example separately from one another, via a group of several feed channels 756 that are arranged next to one another, for example also referred to as filling necks 756 or filling chutes 756, into the roller gap 104; 104′ or the filling and/or supply chamber 126 formed in the wedge-shaped space 108. As a result, a filling height and thus the pressure in the individual feed channels 756 can, to a certain degree, be set independently of one another and/or of the material consumption in the remaining sections, in particular can be controlled with respect to the same height by open-loop control or closed-loop control. The feed channels 756 or filling necks 756 or filling chutes 756 can essentially also have any cross-section and/or a cross-sectional progression that varies in terms of the height, for example is funnel-shaped, or can be formed by a chute that is divided into individual feed channels 756 by corresponding intermediate walls. In an advantageous embodiment, however, they are formed by, in particular vertically extending, pipes 756 having, for example, a round or rectangular cross-section, which in particular remains constant at least over the maximum filling height intended during normal operation. The feed channels 756 receive the powdered material 004; 004′ indirectly or directly from a provision device 703. Such feed channels 756 or downwardly open outlets of the feed channels 756 are preferably arranged next to one another across a width, which approximately, that is, with a maximum deviation of ±5%, corresponds to the current inside width of the filling and/or supply chamber 126 formed in the wedge-shaped space 108. In a particularly advantageous embodiment, a sensor system comprising at least one sensor 761 is assigned to the feed channels 756, by which a respective filling level in the feed channels 756 can be monitored, for example for at least one lower and/or upper limit value, or detected, for example in at least one region for the filling height. The filling level considered here relates in particular to the material column that is formed or accumulated over the outflow-side outlet of the relevant feed channel 756 or in the lower channel section 756.1, which is arranged downstream from a final control element possibly provided in the feed channel 756. A result of the monitoring process or detection can preferably be fed to an open-loop and/or closed-loop control device, for example, an electronic open-loop and/or closed-loop control circuit or an open-loop and/or closed-loop routine implemented in a data processing device, via a wired or wireless signal connection, which, for example, in turn acts on one or more final control elements used for varying the filling height. The sensor system can generally be based on any mechanism of action that meets the above-described minimum requirement, for example can comprise optically operating sensors 761 that evaluate magnetic or electrical fields or record a mechanical force.

In an advantageous embodiment, the feed channels 756 are designed so as to be transparent or at least translucent for electromagnetic waves of a certain wavelength range, for example allowing these to pass through, at least on a preferably same side pointing, for example, perpendicularly to the progression of the roller gap 104; 104′, so that a fill level can be monitored or detected within the above meaning through the wall or at least a section of the relevant feed channel 756 that has a transparent or translucent design, by means of a sensor 761 operating and/or sensing in the relevant wavelength range. A number of optically operating sensors 761 corresponding to the number of feed channels 756 can be provided or a sensor 761 that is assigned to and shared by the feed channels 756 can be provided, which is preferably designed as a camera 761, in particular as a line camera 761. If the relevant wavelength range is not present with sufficient strength in the spectrum that results from the ambient lighting, a corresponding source can be specifically provided for the relevant wavelength range for use in the incident light method or possibly transmitted light method.

The sensor 761 is preferably designed as a camera 761 operating in the visible wavelength spectrum, wherein the feed channels 756 are formed on at least the side viewed through the camera 761 and in at least the section viewed through the camera 761, or overall are made of a transparent or at least translucent material, in particular made of glass, plexiglass or a transparent or at least translucent plastic material.

In a first advantageous embodiment of such a powder feed device 700; 700′ in the embodiment supplying the filling and/or supply chamber 126 in sections, the feed channels 756 provided next to one another, for example directly or spaced apart from one another, have a line connection to at least one provision device 703 and can be filled via the same on the input-side or from above with powdered material 004; 004′ (see, for example, FIG. 22).

In an advantageous embodiment, for example with respect to the complexity, several or all of the feed channels 756 that are provided next to one another have a line connection to the same provision device 703 and can be filled by the same simultaneously on the input-side or from above with powdered material 004; 004′.

Feeding material into the feed channels 756 via individual conveyor belts, vibrators or the like can be dispensed with for the case that is preferred here, wherein a provision device 703 that is jointly assigned to the one or more feed channels 756 to be supplied is provided, for example at a level located above the entrance into the feed channels 756, and the powdered material 004; 004′ can be fed from there into the relevant feed channels 756 or flow out of the same, in particular solely by the action of gravity.

Output-side outlets of the feed channels 756 are preferably immersed into the wedge-shaped space 108 or filling and/or supply chamber 126 formed over the roller gap 104; 104′. A supply reservoir 703, for example in the embodiment of a supply hopper 703, can preferably be provided as the provision device 703, which in a lower region has a line connection via one or more corresponding openings to the feed channels 756 for conducting through the powdered material 004; 004′.

So as to be able to fill the feed channels 756 individually and independently of one another, for example when a material consumption possibly fluctuates across the width, that is, across the group of feed channels 756, or for other reasons, positioners 762, for example valves 762, in particular ball or flat slide valves 762, which are assigned to the respective feed channels 756, are provided as final control elements, by which an input-side infeed of powdered material 004; 004′ into the feed channels 756 or a flow of powdered material 004; 004′ in the feed channels 756 into a respective downstream channel section 756.1 can be varied by way of a positioning drive 763, that is, for example can be selectively opened or closed or, in an advantageous refinement, can possibly be adjusted in terms of the degree of opening or a flow rate over an adjustment range. The positioners 762 allow the filling heights in the individual feed channels 756, in particular in a respective channel section 756.1 arranged downstream from the positioner 762, to be individually adjusted and to be individually controlled by open-loop or closed-loop control in connection with an above-described sensor system, which monitors and/or detects the filling height, by way of the open-loop and/or closed-loop control device. For example, in one embodiment, the above-described positioners 762 designed, for example, as valves 762 are adjusted or can be adjusted using an appropriately equipped sensor system, that is, one or more above-described sensors 761, in particular in conjunction with a sensor 761 designed as a camera 761, in terms of the open/closed function in a control loop based, for example, on a 2- or 3-step controller. In a particularly advantageous embodiment, valves 762 having variable opening degrees or flows, for example pinch valves 762, are provided as final control elements or positioners 762, comprising, for example, respective positioning drives 763 designed in particular as proportional drives 763, which in conjunction with a sensor 761 detecting the fill level, for example a camera 761, enable controlled feeding, and thus a constant filling height in the particular feed channel 756.

The feed channels 756 can have a multi-piece design and, for example, be interrupted by the relevant positioner 762. It is also possible for a channel section 756.1 of the channel 756 located beneath the positioner 762 to be made of a rigid material, for example of plastic material, glass or plexiglass, while a channel section 756.2 located above or upstream from the positioner 762 can have a flexible design, for example in the form of a hose line. Downstream from the positioner 762, a lateral opening 764, which is located, for example, at the end of a branch that is oriented at least slightly upwardly, can be provided in the feed channel 756 for venting and/or ventilating the channel interior. Instead of the positioner 762 located in the drop path of the relevant channel 756, the positioner can also be provided on the input side of the channel 756.

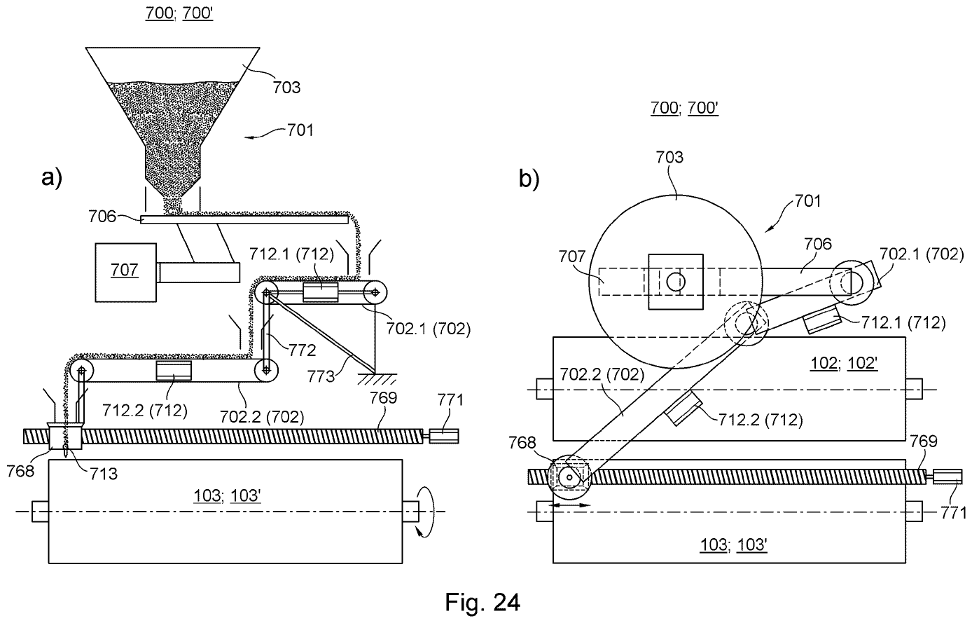

In a further advantageous embodiment of such a powder feed device 700; 700′ (see, for example, FIG. 23) in the embodiment supplying the filling and/or supply chamber 126 in sections, powdered material 004; 004′ can be fed individually to the, or at least several of the, feed channels 756, which are provided next to one another, for example directly or possibly spaced apart from one another, from at least one provision device 703 consecutively via a same conveying device 702 or via several conveying devices 702 that can each be operated separately and independently from one another. A conveying device 702 that can be moved with the outlet-side end or outlet along the group of feed channels 756, for example in the embodiment of a conveyor belt 702 or a screw conveyor, or of a linear conveyor system 702, in particular a conveyor belt system 702, comprising several coupled linear conveyors 702.1; 702.2, for example in the embodiment of several, or in particular two, conveyor belts 702.1, 702.2, vibrating conveyors or screw conveyors, can be provided as a conveying device 702 that consecutively supplies different feed channels 756. One example is set out, for example, in connection with FIG. 24 for a following exemplary embodiment based on a transversely movable conveyor belt 702 or in particular conveyor belt system 702. In the embodiment comprising separate conveying devices 702, respective linear conveyors 702; 704 can be assigned to the feed channels 756, which can be designed, for example, as conveyor belts 702, as vibrating conveyors 704 or as screw conveyors.

The output-side outlets of the feed channels 756 are also immersed here during normal operation into the wedge-shaped space 108 or filling and/or supply chamber 126 formed over the roller gap 104; 104′.

In this embodiment as well, the respective feed channel 756, for example in the form of a filling neck 756 or filling chute 756, can essentially have any cross-section and/or a cross-sectional progression that varies in terms of the height. In the advantageous embodiment shown here, the feed channels 756 are formed by rectangular filling chutes 756, which are formed, for example, by individual rectangular pipes 756 or, for example, by rectangular sections of a chute 766 divided by partitions 767. A hopper-shaped expansion can be provided in an upper part of the feed chute 766, which facilitates targeted feeding of the powdered material 004; 004′.

As was already described above for the feeding in sections, in an advantageous embodiment a sensor system, comprising at least one sensor 761 operating and/or sensing in a wavelength range of electromagnetic waves, is also provided here on one side of the feed channels 756, in particular on a same side and/or a side located laterally with respect to the alignment of the feed channels 756, the sensor being directed from the side at at least one section of one or more feed channels 756 for ascertaining a fill level, wherein the feed channels 756, on at least the section observed by the sensor 761, are designed so as to be transparent, or at least translucent, in at least the wavelength range that is relevant for the sensor 761, that is, the sensitive or working wavelength range. A number of sensors 761 operating in the relevant wavelength range corresponding to the number of feed channels 756 can be provided or advantageously a sensor 761 that is assigned to and shared by the or several of the feed channels 756 can be provided, which is preferably designed as a camera 761, in particular as a line camera 761.

As soon as the roller gap 104; 104′ or the filling and/or supply chamber 126, for example at the start of a production run, has been filled up to the lower pipe end, the powdered material 004; 004′ becomes backed up in the particular feed channel 756 since it cannot flow off completely, for example due to limited flowability and/or friction. The sensor system monitors and/or detects the fill level in the feed channels 756 in the manner set out above.

Instead of open-loop or closed-loop control of the fill level by way of assigned positioners 762, the fill level here is controlled by open-loop or closed-loop control via the material being fed into the individual feed channels 756, in particular via an appropriate activation of a traversing drive and/or a conveying rate of the shared conveying device 702 or via the conveying rate of the respective separate conveying devices 702. In a first variant, the sensor system, that is, the sensor or sensors 761, in particular the sensor 761 designed as a camera 761, can form a control loop via the open-loop control and/or closed-loop control device or an electronic open-loop and/or closed-loop control circuit comprised thereby or an open-loop and/or closed-loop routine implemented in a data processing device together with a drive means effectuating the traversing movement, that is, the movement extending in the direction of the width of the rollers 102; 102′; 103; 103′ or of the filling and/or supply chamber 126 (indicated, for example, in FIG. 23 by a double arrow) and/or with a drive means determining the conveying rate of the shared conveying device 702, the control loop maintaining the fill level in the feed channels 756 above a minimum height or target height or within a permitted range. For this purpose, for example, either the outlet of the shared conveying device 702 oscillates back and forth continuously across the width of all feed channels 756 located in the working width and, as needed, material is dispensed by a corresponding activation of the drive means related to the conveying rate when a feed channel 756 that has a deficit, that is, has a fill level that is below a limit value, is being passed over. As an alternative, the conveying device 702 can be deliberately moved with the outlet thereof over a feed channel 756 that has a deficit by activation of the drive means effectuating the traversing movement or transverse movement, and material can be dispensed by appropriate activation of the drive means related to the conveying rate.

In a further advantageous embodiment of a powder feed device 700; 700′, by which powdered material 004; 004′ can be fed into a filling and/or supply chamber 126 formed in the region of the wedge-shaped space 108 above the gap 104; 104′ between the first roller 102; 102′, powdered material 004; 004′ can be fed from a dispensing device 701 via an outlet or a downstream end of a conveying device 702 into the filling and/or supply chamber 126.

The outlet or the downstream end of the conveying device 702, however, extends across a width that only corresponds to a part, for example less than a quarter, of the width of the filling and/or supply chamber 126 to be supplied (see, for example, FIG. 24). So as to nonetheless be able to supply the filling and/or supply chamber 126 across the width thereof with the powdered material 004; 004′ , the conveying device 702 which is arranged directly upstream from the filling and/or supply chamber 126, and which at least in the region of the downstream end or outlet thereof is only partly as wide compared to the width of the filling and/or supply chamber 126, can be moved in both directions at least with the outlet-side end or outlet thereof over a width or partial width of the filling and/or supply chamber 126, which here is also denoted by the term traversable. Even though the movement in the direction of the width of the filling and/or supply chamber 126 can also be provided along a progression of the gap 104; 104′ that is arcuate or curved otherwise or along a straight line that is inclined with respect to the progression of the gap 104; 104′, the end or an outlet of the partly wide conveying device 702 can be moved along a direction parallel to the progression of the roller gap 104; 104′, and preferably horizontally, and/or approximately, that is, each side having, for example, a maximum deviation of ±5%, across the entire currently set or present width of the filling and/or supply chamber 126.

The conveying device 702 is the powdered material 004; 004′ from a or via a metering device 701; 701′ that, for example, controls the dispensed amount, for example an outlet cooperating with a vibratory drive, a controllable screw conveyor or a controllable dispensing valve.

In a particularly advantageous embodiment, the powder feed device 700; 700′ comprises a metering jogger 701; 701′ as the metering device 701; 701′, by which a constant stream and/or controllable stream, in particular with an accuracy in the dispensed amount having a deviation of no more than 3%, in particular no more than 2% from the target dispensed amount, of powder mixture 004; 004′, to the conveying device 702; 702.1, 702.2, which in particular can be operated with a defined and/or specifiable, in particular variable speed. The conveying device 702; 702.1; 702.2 is preferably designed as a conveyor belt system 702, comprising at least one first linear conveyor 702.1, in particular conveyor belt 702.1, and at least one further or second linear conveyor 702.2, which is assigned to a same conveyor line downstream and, for example, is longer compared to the first linear conveyor 702.1, in particular a conveyor belt 702.2, to which the material 004; 004′ coming from the first linear conveyor 702.1 or conveyor belt 702.1 can be transferred. The linear conveyor 702 or linear conveyor system 702.1, 702.2 and/or at least the downstream end thereof are traversable, that is, can be moved back and forth toward both sides, across a feed width relevant for feeding the powder, preferably with the overall conveyor line length remaining the same, by a drive device, in particular a linear drive, over the filling and/or supply chamber 126, in particular axially parallel to the progression of the roller gap 104; 104′.

The conveying device 702 is preferably designed as a linear conveyor system 702.1, 702.2, in particular conveyor belt system 702.1, 702.2 comprising multiple, for example two, coupled linear conveyors 702.1; 702.2, in particular conveyor belts 702.1; 702.2, which in particular can be operated at a constant and/or specifiable speed, wherein this system, in the region of the downstream end thereof, is coupled to the drive device which preferably extends in an axially parallel direction to a height above the first gap 104; 104′, for example a traversing drive, in particular linear drive 768, 769, 771 and can be moved by the same, in particular in the axially parallel direction, at a defined and/or specifiable, in particular variable, speed between two lateral end positions, which determine the feed width, back and forth over the first gap 104; 104′. The linear drive 768, 769, 771 comprises, for example, a linear guide, on or at which a driven slide 768 runs, a transversely extended and driven belt, to which the downstream end is coupled, or in particular a threaded spindle 769, which carries a slide 768 that is coupled to an end region of the linear conveyor 702; 702.1, 702.2, for example spindle slide 768. A drive means 771 driving a threaded spindle 769 or a belt is designed, for example, as a motor 771, in particular as a servo motor 771, which can, for example, be alternately operated clockwise and counter-clockwise.

For the preferred embodiment of a linear conveyor system 702.1, 702.2, in particular conveyor belt system 702.1, 702.2 comprising multiple, for example two, coupled linear conveyors 702.1, 702.2, in particular conveyor belts 702.1; 702.2, these can generally be driven in a coupled manner by way of a shared drive means 712. In an advantageous embodiment, however, a dedicated drive means 712.1, 712.2, for example a respective drive motor 712.1; 712.2, in particular servo motor 712.1; 712.2, is provided for each linear conveyor 702.1; 702.2 or each conveyor belt 702.1; 702.2 of the linear conveyor system 702.1; 702.2 or conveyor belt system 702.1; 702.2.

The downstream end of the further upstream, for example first, provided linear conveyor 702.1, in particular conveyor belt 702.1, of the linear conveyor system 702.1, 702.2, in particular conveyor belt system 702.1, 702.2 is connected in an articulated manner to the upstream end of the second or last linear conveyor 702.2, in particular conveyor belt 702.2, that adjoins downstream by way of a coupling 772, for example a shaft 722, in such a way that these can be pivoted relative to one another about a, for example vertically extending, shared axis of rotation. The shaft 722 or coupling 722 can, for example, be supported by a brace 773, for example a mount 773 that is fixed to the frame but can be pivoted about an axis of rotation extending parallel to the shaft 722.

A sensor 713, for example a fill level sensor 713, preferably embodied as an ultrasonic sensor 713, is provided or arranged in the region of the downstream end of the linear conveyor 702 or linear conveyor system 702.1, 702.2 or at the slide 768 so as to be entrained with the moving end or slide 768 and, for detecting or monitoring the filling height, is directed from above at the powdered material 004; 004′ present in the filling and/or supply chamber 126. As an alternative thereto, a sensor system comprising at least one sensor 761, for example in the form of the above-described lateral sensor 761, can be provided, by which a fill level can be ascertained continuously or at intervals across the width of the filling and/or supply chamber 126. A spatially resolved result can then be supplied to the open-loop and/or closed-loop control device for forming a control loop described hereafter.

An open-loop or closed-loop control of the fill level here takes place, for example, in a manner similar to an embodiment described above for feeding in sections, by feeding material to points having an insufficient filling height, in particular by way of an appropriate activation of the traversing drive and/or a conveying rate of the partly wide conveying device 702; 702.1, 702.2. In a first variant, the relevant sensor 713, 761, together with the open-loop and/or closed-loop control device or an electronic open-loop and/or closed-loop circuit comprised thereby or an open-loop and/or closed-loop control routine implemented in a data processing device, together with the drive means 771 effectuating the traversing movement, that is, the movement extending in the direction of the width of the roller 102; 102′; 103; 103′ or of the filling and/or supply chamber 126, and/or the or a drive means 712; 712.1; 712.2 determining the conveying rate of the partly wide conveying device 702; 702.1; 702.2, can form a control loop, which maintains the fill level in the filling and/or supply chamber 126 in the entire width being monitored above a minimum height or at a target height or within a permitted range. For this purpose, for example, the downstream end or an outlet of the partly wide conveying device 702 oscillates back and forth continuously across the monitored width and, as needed, material is dispensed by a corresponding activation of the drive means 712; 712.1; 712.2 related to the conveying rate when a region that has a deficit, that is, has a fill level that is below a limit value, is being passed over. In a variant comprising a lateral sensor system, alternatively the end or outlet can be moved over a section that is recognized as having a deficit by a corresponding control loop, and material 004; 004′ can be deliberately fed there via the partly wide conveying device 702; 702.1; 702.2.

Each of the powder feed devices 700; 700′ in the above-described embodiments can preferably be employed in all above-described embodiments for the coating device 100; 100*, wherein in the case of the embodiment having the simultaneous two-sided application or the embodiment comprising application units 101; 101′ that are offset at the substrate path an above-described powder feed device 700; 700′ is preferably also provided at the other application unit 101′; 101.

The above-described comments regarding the powder feed device 700; 700′ can also be applied to the feeding in application units 101; 102′ in which, in addition to the first and second rollers 102; 102; 103; 103′, a further, for example third, roller is provided downstream from the second roller 103; 103′, the second roller 103; 103′ is provided with a gap for transferring the dry film, which takes over the previously formed dry film 003; 003′ via a gap with the second roller 103; 103′, and in a further gap with a further roller 103′; 106 transfers the dry film 003; 003′ to this further roller or to a carrier substrate 006 to be guided through the further gap. In the latter case, the further gap forms the laminating gap 107; 107′, which is formed on the other side by a roller 103′; 106 that is effective as a counter-pressure roller 103′; 106.

Generally independently of, but advantageously in particular in conjunction with one of the above-described embodiments, variants, configurations, specific embodiments or designs of the coating device 100; 100* and/or one of the above-described embodiments or variants for the powder feed device 700; 700* and/or one of the designs and/or configurations for the machine described in greater detail below, a measuring system 801 or device for determining the density ρ of a material layer 003; 003′ that is conveyed on an outer cylindrical surface of one of the rollers 103; 103′ of the application unit 101; 101′, as is shown by way of example, for example, in FIG. 25, is provided. In conjunction with an above-described coating device 100; 100* and/or an above-described powder feed device 700; 700*, such a measuring system 801 could be conceptually expanded.

The measuring system 801 or device comprises a or the above-described removal device 114; 114′; 116; 116′, which can be placed or is placed against at least a part of the usable working width of the roller 103; 103′, for example the width of the outer cylindrical surface which is effective for the film formation, during rotation for removing at least a part of the material layer 003; 003′ at one point of the circumference of the roller 103; 103′. The removal of at least the part of the material layer 003; 003′ which is relevant for determining the density ρ is carried out by the removal device 114; 114′; 116; 116′ during the rotation of the roller 103; 103′ over an angular range Δφ, for example, also angular interval Δφ, between a first and a second angular position φ1; φ2, wherein, if more than one revolution is to be carried out, a value greater than 360° must be used for the second angular position φ2 corresponding to the traveled angular difference. The part of the material layer 003; 003′ which is relevant for the determination of the density ρ can result from the removal during one, more than one, or a part of a full revolution. Analogously to the relation to an angular range Δφ relevant for the removal or to the relevant angular interval Δφ, hereafter where the relation to the angular position φ1 or the angular range Δφ is not mandatory or a direct relation to the time t is explicitly excluded, a time interval Δt having a first point in time t1 shall be understood to mean the start of the removal at, for example, a first angular position φ1 and a second point in time t2 shall be understood to mean the end of the removal at, for example, a second angular position φ2.

Generally, the material layer 003; 003′ can be removable or removed for sampling purposes by a, for example, above-described removal device 114; 114′ extending across the width of the cylindrical roller surface which is effective for the film formation, over the entire width across a certain length or a certain angular range Δφ. This applies, in particular, for example, in the case of an application unit 101; 101′ by which a material layer 003; 003′ that is interrupted by free sections is applied to the carrier substrate 006.

In a, for example, above-described and advantageous embodiment in which, for example, a material layer 003; 003′ that is uninterrupted over a multitude or plurality of revolutions of the above-described laminating roller 103; 103′ is applied to the carrier substrate 006, however, a removal device 116; 116′ is provided, which can be placed or is placed against the outer cylindrical surface for the removal of only a part 008; 008′ of the material layer 003; 003′, in particular a material strip 008; 008′, which is formed in the edge region, that is, in a region that, viewed in the axial direction, is located at an end of the material layer 003; 003′, by an edge strip 008; 008′, at a point of the circumference of the roller 103; 103′ on only a part of the usable working width. The material strip 008 is separated along a cutting line s extending in the circumferential direction and lifted off the material surface. The edge strip 008; 008′ can involve the use of the edge trimming that is used to preserve a straight edge.

The measuring system 801 or device furthermore comprises a weighing unit 802, on which a removed, in particular defined and/or determinable part 008; 008′ of the material layer 003; 003′ previously conveyed on the roller 103; 103′ can be or is collected. For this purpose, the removed part of the material layer 003; 003′ used at least for the determination of the density p is collected, for example, in a weighing receptacle 803 mounted on a scale 809, for example a weighing pan 803, and the mass m thereof is thus determined. For example, a dead time can be or have been considered, which takes into account the path of the removed part of the material layer 003; 003′ used for the determination of the density ρ from the point where it is peeled off to the weighing unit 802.

Generally, an embodiment is conceivable in which, during operation of the coating device 100; 100*, an edge strip 008; 008′ is continuously removed and collected on the weighing unit 803 or in the appropriately dimensioned weighing receptacle 803, wherein the mass m of the part 008; 008 of the material layer 003; 003′ which is removed over the angular range Δφ relevant for the determination of the density p is ascertained by determining a difference between the mass m recorded at the point in time t2 of the end and the point in time t1 of the start of the determination process by the weighing unit 802.

In an advantageous embodiment, which is shown, by way of example, in FIG. 25, for example, in which, for example during the operation of the coating device 100; 100*, likewise an edge strip 008; 008′ can be or has been continuously removed and possibly received by a collecting device 117; 117′ and possibly is or can be discharged via the same, a separation device 808 actuated by way of, for example, a drive means 818, is provided by which, for example over a time interval Δt which is defined and/or correlates with the removal in the relevant angular range Δφ, for example over a dead time, the or a part 008; 008′ of the material layer 003; 003′ which is removed for the determination of the density ρ in the relevant angular range Δφ can be fed to the weighing unit 802 intended specifically for this purpose, in particular the weighing receptacle 803. The separation device 808 can be designed as a diverting unit 808 in the form of a switch 808 comprising a switch point 817 actuated, for example, by a drive means 818 or in the form of a diverter 808 comprising a slide 817 or base 817 actuated, for example, by the drive means 818. In a modification comprising, for example, a material layer 003; 003′ that is interrupted by free sections, a number of material layer sections to be used, for example, for the determination can have an edge region 008 separated in the above-described manner by such a separation device 808, wherein, for example, possibly other edge regions 008 are received in a collecting device 117; 117′. The sample material of the removed material layer 003; 003′ which is received on or in the weighing receptacle 803 can, for example, be emptied, in particular poured, into a, for example, larger material receiving system 816, for example a receptacle 816, for example after a determination cycle, by way of a drive means 814, for example a tilt drive 814.

Furthermore, a measuring device 806 is provided, by way of which a thickness d, for example layer thickness d, of the material layer 003; 003′ conveyed on the roller 103; 103′ can be determined. In a first approximation, the thickness d003, for example layer thickness d003, generally at any location over the width b003; b003′ of the material layer 003; 003′ and/or at a point in time of a stationary operation of a device comprising the rollers can be incorporated as such a thickness, preferably however a thickness d008 or layer thickness d008 of the material layer 003; 003′ in the material strip 008; 008′ to be removed. Such a measuring device 806 is preferably based on a contactless measurement and is, for example, designed as an ultrasound-based, an inductive or a capacitive measuring device 806 comprising a corresponding measuring head.

The determination of the density p is carried out, for example, in data processing means 811 which are provided for this purpose and, for example, are provided in a control unit 807 controlling the process for the determination of the density ρ, for example according to: ρ=m/V=m/(A·d).

In the simplest case involving, for example, a sufficiently straight side edge of the material layer 003; 003′ that is conveyed on the roller 103; 103′ and a width 008 of the material strip 008; 008′ to be removed or removed which is known via the axial position of the removal device 116; 116′, it is possible, using a piece of information about an angular range Δφ which is passed over during the sampling process of the part 008; 008′ of the material layer 003; 003′ which is relevant for the determination of the density ρ and a radius r of the roller 103; 003′, to directly ascertain a measure for the surface area A and, together with the layer thickness, a measure for the volume V of the removed part 008; 008′ of the material layer 003; 003′ which is relevant for the determination of the density ρ. The known width b008 can be incorporated as the width b in the determination of the density ρ and, in a good approximation, the radius of the roller 103; 103′ in the region of the usable outer cylindrical surface itself or a radius that has been upwardly revised, for example to a small extent, for example by the mean layer thickness d008, can be directly incorporated as the radius r. When the width b is known, the surface area A for the above relationship is ascertained, for example, according to: A=b·2 r π·Δφ/360°.

If, for example, no sufficiently straight side edge of the material layer 003; 003′ conveyed on the roller 103; 103′ is present and/or a width b008 of the material strip 008 to be removed is not known, a sensor system 804, for example an optically operating sensor 804, can be provided, for example, by which that the width b; b008 of the edge strip 008; 008′ to be removed or a progression of the width b; b008 or of the side edge over the angular range Δφ to be considered can be ascertained and, for example, an average width can be determined therefrom, wherein in the latter case the average width is used as the width b in the above relationship.

In an advantageous alternative for the case of an unknown and/or varying width b008 of the material strip 008, a sensor system 804 can be provided with appropriate evaluation means, by which the surface area A is directly ascertained, for example, integrated over the course of the rotational movement, when the position of the cutting line s is known, taking into consideration the rotational movement over the angular range Δφ or a corresponding time interval Δt as well as an above-described radius r.

The sensor system 804 or the optically operating sensor 804 can, for example, be formed by a camera 804, in particular a line camera 804.

A piece of information representing the respective current angular position φ of the roller 103; 103′ or the information about an angular range Δφ which is passed over during the sampling process of the part 008; 008′ of the material layer 003; 003′ which is relevant for the determination of the density ρ can be fed to the data processing means 811, for example via a signal connection from an angular position encoder 813, which, for example, is indirectly or directly coupled to the axis of the rotation of the roller, or via a signal connection from a drive controller indirectly or directly specifying the angular position of the roller 103; 103′.

The density ρ of a material layer 003; 003′ conveyed on an outer cylindrical surface of an above-described roller 103; 103′ is thus determined by rotating the roller 103; 103′carrying the material layer 003; 003′ on the outer cylindrical surface thereof about the axis of rotation R103; R103′ thereof, by removing from the outer cylindrical surface the material layer 003; 003′ over the entire or a part 008; 008′ of the width b003; b008 during the rotation by a removal device 114; 114′; 116; 116′ over an angular range Ao at a point of the circumference between where the material layer 003; 003′ is received and where it is transferred downstream to a further roller 103; 103′ or to, for example, an above-described carrier substrate 006, by ascertaining the mass m of the part 008 of the material layer 003; 003′ which has been removed over the angular range Ao by weighing, by determining a layer thickness d; d003; d008 of the material layer 003; 003′, preferably in the region to be removed, by way of a measuring device 806 even before the removal, by determining a surface area A of the material layer 003; 003′ removed or to be removed in the angular range Δφ on the roller in, for example, one of the above-described ways, and finally obtaining a value for the density of the material layer 003; 003′ conveyed on the roller 103; 103′ from the surface area A, the mass m and the layer thickness.

The ascertained value for the density ρ can, for example be displayable via a display device 812, for example a display 812, and/or be used in a control unit controlling the coating device 100; 100*.

By means of an above-described device for determining the density ρ or a corresponding method, the density p and thus a quality of the material layer 003; 003′ designed, for example, in the above manner as a powder composite film 003; 003′ and/or active material layer 003; 003, for example in the form of a dry film 003; 003′, can be checked during production, in line or in a specifically provided run, and possibly, if necessary, counter-measures can be taken if a deviation from a target value or permitted target range occurs. These measures can be, for example if the p density is too low, an increase in a pressure, for example via the above-described linear force or a reduction in the gap width in an above-described roller gap 104; 104′ or, for example, if the density is too high, for example a decrease of a pressure, for example via the above-described linear force or an increase in the gap width in a roller gap 104; 104′, for example if the density p is too low, a reduction of a gap width. Instead of or in addition, a modification of the powder composition and/or of a temperature at, for example, one of the rollers 102; 102′; 103; 103′ involved in the formation of the material layer and/or a modification of an above-described speed differential between the rollers 102; 102′; 103; 103′ involved in the formation of the material layer are also possible.

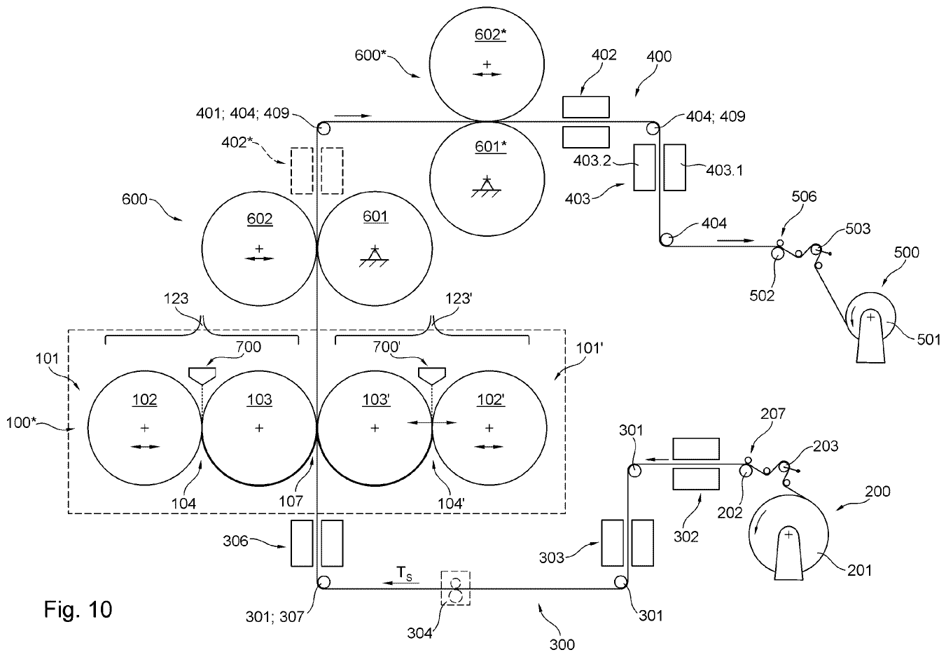

A machine for producing, in particular in an inline process, a multi-layer product (see, for example, FIG. 3, FIG. 10, FIG. 15 or FIG. 16), which on at least one side of a carrier substrate 006 comprises an above-described dry film 003; 003′ made of a powder mixture, preferably comprises a substrate infeed 200, by which the carrier substrate 006 can be fed to the machine on the input side, a first substrate path section 300, via which the carrier substrate 006 can be fed to an application stage 100; 100* for applying the dry film 003; 003′ to at least one side of the carrier substrate 006, and a second substrate path section 400, via which the carrier material 006 provided on at least one side with the dry film 003 can be fed to a product receiving system 500, by which the product can be combined into product bundles, for example into reels or piles.

In a particularly preferred embodiment, the application stage 100; 100* is designed in an above-described embodiment, design, configuration, specific embodiment or variant for the above-described device 100; 100*. All embodiments, designs, configurations, specific embodiments of the first group of exemplary embodiments are to be able to take the place of the application stage 100 shown by way of example in FIG. 3, and all of the second group are to be able to take the place of the application stage 100* shown by way of example in FIG. 10, FIG. 15 or FIG. 16. In the exemplary embodiments for the machine shown in FIG. 15 and FIG. 16, it is also possible for embodiments, designs, configurations, specific embodiments or variants of the first group to be used as variants for the application stage 100, that is, comprising separate application devices 101; 101′.

In an advantageous embodiment, the substrate infeed 200 is formed by a substrate unwinder 200, in particular a reel changer 200, preferably by a reel changer 200 comprising several reel spots and/or qualified for a non-stop reel change. Advantageously, it can comprise a substrate guide element 202 designed as a roller 202 that is positively driven by a motor, in particular a draw roller 202, and/or a substrate guide element 203 in the form of a dancer roller 203, which, for example, is spring preloaded transversely to the substrate path at a lever. At the substrate unwinder 200, the carrier substrate web 006 is unwound and fed, at the unwinding location, on the input side, to the substrate path leading through the machine.

For the case of a draw roller 202 that is comprised by the substrate unwinder and, for example, structurally assigned thereto (see FIG. 3 or FIG. 10, for example), this draw roller can be comprised by a drawing unit 207, in particular infeed unit 207, which, for example, in addition to the draw roller 202 comprises a drive means that drives the draw roller 202, in particular independently of other draw rollers, and can be controlled by closed loop or open loop control in terms of the speed, in particular drive motors, for example in the form of a servo output motor, and/or comprises pressure rollers that can be placed against the draw roller 202 to increase the friction. The roller 202 or the drive means, depending on the web tension conditions and/or web tension requirements that exist in front of and after the roller 202, can also be operable or operated as a generator or so as to block the forward feed of the carrier substrate web 006, for example so as to build or maintain a certain and/or desired web tension in the substrate path section 300 that follows and extends, for example, up to a next clamping or web feed point or in a part of the substrate path section 300 formed by a following substrate path segment.

Still structurally assigned to the substrate path in the reel unwinder 200, a substrate guide element 208 can be formed as a measuring roller 208, for example a web tension measuring roller 208 (shown by way of example for all embodiments in FIG. 16, for example) in the substrate path, by which, for example, the web tension can be ascertained so as to use the same, for example, for controlling the web tension, for example via the conveying speed of individual subassemblies 100; 100*, 600 or one or more web guide elements 202; 308; 401; 502, which are in particular positively driven by a motor.

The substrate infeed 200 designed as a reel changer 200 advantageously comprises a reel drive, which is driven mechanically independently of the remainder of the machine and/or by an individual motor, and/or a lifting device for supporting a reel loading and/or reel unloading process.

Still located in the substrate path segment attributable to the substrate infeed 200 and/or in the following first substrate path 300, in an advantageous embodiment a device for the lateral web edge control 204 (shown by way of example for all embodiments in FIG. 15, for example), in particular a sensor system detecting a web edge and a final control element effectuating a lateral offset of the carrier substrate, for example a turner bar pair that can be pivoted about an axis extending perpendicularly to the transport direction Ts, can be provided. In a particularly advantageous embodiment, the web edge controller 204 is combined with a gluing device 206, for example a gluing table 206.

Instead or in addition, in an advantageous embodiment a spreader, in particular a single-element or multi-element web guide element having a convexly extending outer cylindrical surface, is provided still in the substrate path segment of the substrate infeed 200 and/or in the first substrate path 300.

In an advantageous refinement, a one-piece or multi-piece pretreatment station 302, in particular a cleaning and/or deionizing station 302, is provided in the first substrate path 300, by way of which the carrier substrate 006 is or can be freed from superficial impurities, for example dust or cut-off residue, and/or electric charge carriers, on one side or both sides in a contactless or contacting method.

A measuring station 303, in particular comprising a sound-based or radiation-based measuring device 303, is provided in the first substrate path 300, in particular downstream from a possibly provided cleaning operation, by way of which the material thickness of the carrier material 006 can be checked for the thickness and/or homogeneity in the thickness and/or for impurities and, for example in the event of impermissible deviations from a target specification, an optical and/or an acoustic warning signal and/or an error signal is transmitted to a machine controller and/or a control console.

For all embodiments of the machine, in an advantageous embodiment a substrate guide element 208; 307 can be designed as a measuring roller 307 (shown by way of example for all embodiments in FIG. 15 and FIG. 16, for example) in a substrate path segment that is structurally assigned to the reel changer 200 and/or in a substrate path section of the first substrate path 300 following the same, by which, for example, the web tension can be ascertained so as to use it, for example, for controlling the web tension, for example, via the conveying speed of individual subassemblies 100; 100*; 600 or of one or more web guide elements 202; 308; 401; 502 which are, in particular, positively driven by a motor. It is possible for only one of the two measuring rollers 208; 307 to be provided or advantageously for both measuring rollers 208; 307 to be provided, wherein in the latter case, for example, the downstream measuring roller 307 is used for ascertaining purposes and/or for control, as described below, of the web tension in the substrate path segment arranged upstream from the first or only application point.

In an advantageous refinement, for example a pretreatment station 304 designed as an application station 304 is provided in the first substrate path 300, by which a binder and/or a primer can be applied to one side or both sides of the carrier material 006. In this case, a dryer, which is not shown, for example a hot air or radiation dryer, can preferably be provided directly downstream from the application station 304.

Essentially independently of, but advantageously in conjunction with one or more of the other variant embodiments of the machine, in an advantageous refinement a thermal pretreatment station 306, in particular a temperature control station 306, for example an infrared radiation source 306, can be provided in the substrate path immediately upstream from the application stage 100; 100*, that is, for example, downstream from the last substrate guide element 301; 307 cooperating with the carrier substrate web 006, by which the carrier material 006 can preferably be heated to above the ambient temperature, in particular to above 60° C., preferably to at least 80° C. This can, for example, be of particular advantage for activating a cohesion-supporting or cohesion-inducing agent 007; 007′ that is provided on or applied to the carrier substrate 006. Generally independently thereof, but advantageously in conjunction with such a temperature control station 306, a sensor 311 for ascertaining the temperature of the carrier substrate web 006, for example a temperature sensor 311, in particular a temperature sensor 311 operating in a contactless and/or radiation-based manner, can be provided. The sensor 311, for example as a temperature sensor 311, together with the possibly provided temperature control station 306, can be an integral part of a control loop for controlling the temperature of the carrier substrate web 006.

Instead of a draw roller 202 attributable to, or a drawing unit 207 attributable to, the substrate unwinder 200, or possibly in addition thereto, a draw roller 308 or a drawing unit 309 can be provided in the substrate path section 300 that follows the substrate unwinder 200 and/or leads to the point of the first or only dry film application, that is, to the first or only laminating gap 107; 107′. If only one draw roller 202; 308 or only one drawing unit 207; 309 is provided in the substrate path between where the unwinding from the reel 201 takes place and where the entry into the first or only laminating gap 107; 107′ takes place, such a draw roller 202; 308 or such a drawing unit 207; 309 can generally be structurally assignable or assigned to the substrate unwinder 200, a substrate path section 300 extending between the substrate unwinder 200, in particular where the unwinding takes place, and the application stage 100; 100*, in particular the first or only application point, or can structurally be assignable also to the application stage 100; 100*. What is essential here is that such a draw roller 202; 308 or such a drawing unit 207; 309 is arranged upstream from the first application point, that is, the first or only laminating gap 107; 107′, in the substrate path, for example so as to build or maintain a certain and/or desired web tension in the following substrate path section or in a part of the substrate path section formed by a following substrate path segment. Corresponding to the drawing unit 207 that was already described above, the drawing unit, for example in addition to the draw roller 308, comprises a drive means that drives the draw roller 308, in particular independently of other draw rollers, and that can be controlled by closed loop or open loop control in terms of the speed, for example in the form of a servo output motor, and/or pressure rollers that can be placed against the draw roller 308 to increase the friction. Depending on the web tension conditions and/or web tension requirements that exist in front of and after the roller 308, the roller 308 or the drive means can also be operable or operated as a generator or so as to block the forward feed of the carrier substrate web 006, for example so as to build or maintain a certain and/or desired web tension in the substrate path section that follows and extends, for example, up to a next clamping or web feed point or in a part of the substrate path section formed by a following substrate path segment.

In an advantageous embodiment, a calendering unit 600 comprising two calendering rollers 601; 602 forming a calendering gap between each other is provided in the second substrate path 400, in particular in the substrate path immediately downstream from the application stage 100; 100*, of which, for example, at least one, preferably both, can be heated, in particular can be heated in such a way that the outer cylindrical surfaces thereof, at an ambient temperature of 25° C., can be brought to at least 80° C., advantageously to at least 100° C., preferably to at least 120°, and/or between which a compression with a preferably adjustable linear force of at least 5.0 kN/cm, advantageously at least 7 kN/cm, preferably a linear force between 5 kN/cm and 30 kN/cm can be applied. The product strand 002 coated at least on one side can be guided through the calendering gap for the purpose of further compacting the dry film 003; 003′, using pressure and/or an increased temperature in relation to the ambient temperature.

Generally independently of, but advantageously in conjunction with one or more of the other variant embodiments of the machine, in an advantageous embodiment a cooling unit 402 is provided in the second substrate path 400, in particular in the substrate path downstream from a possibly provided calendering unit 600, by which a product strand 002 that is guided through can be cooled, for example, by at least 20° C., in particular by at least 50° C.

Generally independently of, but advantageously in conjunction with one or more of the other variant embodiments of the machine, in an advantageous refinement an inspection device 403; 403.1; 403.2, which is in particular based on an optical and/or acoustic measurement, for example comprising one sensor 403.1 that is directed toward one side and one sensor 403.2 that is directed toward the other side, is provided in the second substrate path 400, by which the product surface can be checked for imperfections, for example for the completeness of the surface and/or thickness of the applied dry film 003; 003′. As is shown in FIG. 15, for example, the inspection device 403; 403.1; 403.2 can be provided in the substrate path downstream from the calendering unit 600 or, as is shown in FIG. 16, for example, in the substrate path downstream from the application stage 100; 100′, but upstream from the calendering unit 600. In the first case, defects caused by the calendering process can be recognized, however, in the second case, defects that may be caused in the application stage 100; 100′ are determined as early as possible.

Generally independently of, but advantageously also together with other variant embodiments of the machine, in particular, however, in conjunction with an inspection device 403; 403.1; 403.2 provided at the substrate path, a device for defect marking 412 is provided in an advantageous refinement, which can be formed, for example, by a printing device, for example an ink jet print head, or an injection device, wherein the latter, for example, can introduce a physical marking means, for example a so-called marking flag, into the carrier substrate web 006.

For all embodiments of the machine, in an advantageous embodiment at least one substrate guide element 409 can be designed as a measuring roller 409 in the second substrate path 400, by which, for example, the web tension can be ascertained so as to use it, for example, for controlling the web tension, for example, via the relative conveying speed of individual subassemblies 100; 100*; 600 or of one or more web guide elements 202; 308; 401; 502 which are, in particular, positively driven by a motor. Preferably, at least one substrate guide element 409 is designed as a measuring roller 409, at least in the substrate path segment of the second substrate path section 400 which is arranged downstream from the application stage 100; 100*, in particular the point of the last or only application, and arranged upstream from the calendering unit 600, in particular the point of the calendering process, in particular preferably, however, both in the described substrate path segment and in the substrate path segment arranged downstream from the calendering unit 600. Instead or in addition, a substrate guide element 507, which is structurally assigned to the product winder 500, can be designed as a measuring roller 507 that is arranged downstream from the calendering unit 600 in the substrate path.

So as to be able to ensure that the substrate moves optimally through the application stage 100; 100*, in an advantageous embodiment a substrate guide element 401, which is designed as a draw roller 401 that is positively driven by a motor, is provided in the second substrate path 400, preferably immediately downstream from the application stage 100; 100*, but upstream from a possibly provided calendering unit 600. This draw roller can be comprised by a drawing unit 411, which, for example in addition to the draw roller 401, comprises a drive means that drives the draw roller 401, in particular independently of other draw rollers, and that can be controlled by closed loop or open loop control in terms of the speed, for example in the form of a servo output motor, and/or pressure rollers that can be placed against the draw roller 401 to increase the friction. Depending on the web tension conditions and/or web tension requirements present upstream and downstream from the roller 401, the roller 401 or the drive means can generally also be operable or operated as a generator or so as to block the forward feed of the carrier substrate web 006, however here is operated or operable so as to build and/or maintain a web tension on the upstream substrate path segment by way of a motor, that is, so as to convey the carrier substrate web 006 in the transport direction T_{S} or with a lead compared to, for example, the speed at a next draw roller 202; 301 upstream and/or the circumferential speed of the last or only laminating roller 107; 107′ or of the pair of laminating rollers 107; 107′.

As an alternative or in addition, in a preferred embodiment a web tension equalizing and/or control device 406 (for example, shown by way of example for all embodiments in FIG. 15), comprising, for example, a dancer roller 407, is provided in the second substrate path 400 between the application stage 100; 100* and the calendering unit 600, by which, for example, fluctuations in the web tension can be equalized and/or the conveying speed of an upstream or downstream subassembly 100; 100*; 600 or of one or more in particular motor-driven web guide elements 202; 308; 401; 502 can be controlled.

For all of the embodiments and variants of the machine described here, one specific embodiment is particularly advantageous in which a measuring station 408 for ascertaining the product strand thickness, in particular the total thickness, is provided between the only or last calendering unit 600; 600* and the combination into the product bundle 501 in the product receiving system (for example, shown by way of example for all embodiments in FIG. 15 and FIG. 16).

Instead of or in addition to the above-described cooling unit 402 in the second substrate path section 400, such a or a further cooling unit 402; 504 can also be provided in the substrate path segment attributable to the product receiving system 500 or at the frame thereof. Such a cooling unit 504, can, for example, be formed by a substrate guide element 504 designed as a cooling roller 504. As an alternative, such a cooling unit 504 attributable to the second substrate path section 400 or structurally to the product receiving system 500 can also be formed by several consecutively partially wrapped temperature-controlled cooling rollers 504.1; 504.2.

In a refinement, for example downstream from the possibly provided cooling unit 504, sensor 508 for ascertaining the temperature of the product 002, in particular of the product strand 002, can be in the substrate path downstream from the possibly provided calendering unit 600, however at the latest upstream from the delivery, for example upstream from a winding operation in the product winder 500. The sensor 508, for example as a temperature sensor 508, is in particular designed to be a contactless and/or radiation-based operating temperature sensor 311 and/or can, together with the possibly provided cooling unit 504, be an integral part of a control loop for controlling the temperature.

In an advantageous embodiment, the product receiving system 500 is designed as a product winder 500, in particular in the form of a reel changer 500.

The product winder 500 is preferably qualified for a non-stop reel change and/or comprises an above-described substrate guide element 502 designed as a draw roller 502 that is positively driven by a motor and/or a substrate guide element 503 in the form of a dancer roller 503, which is spring-preloaded transversely to the substrate path at a lever.

So as to be able to ensure that the substrate moves optimally between the possibly provided calendering unit 600 and where the winding on the product winder 500 takes place, in an advantageous embodiment a substrate guide element 502, which is preferably designed as the last substrate guide element 502 prior to where the winding takes place and which is designed as a draw roller 502 that is positively driven by a motor, can be provided in the second substrate path 400 or in a substrate path segment attributable to the product winder 500. This draw roller can be comprised by a drawing unit 506, which, for example in addition to the draw roller 502, comprises a drive means that drives the draw roller 502, in particular independently of other draw rollers, and that can be controlled by closed loop or open loop control in terms of the speed, for example in the form of a servo output motor, and/or pressure rollers that can be placed against the draw roller 502 to increase the friction.

In a particularly advantageous embodiment of a machine comprising a calendering unit 600, in particular for the stable and trouble-free inline continuous operation, both at least one positively driven draw roller 202; 308; 401 and at least one measuring roller 208; 307; 409 for ascertaining a web tension are provided both in a first substrate path segment, which is located between the unwinding location from the substrate reel 201 in the substrate unwinder 200 and the entry into the only or first laminating gap 107; 107′ of the application stage 100; 100*, and in a second substrate path segment, which is located between the exit location of the carrier substrate web, which by then has been provided with the dry film 003; 003′ at least on one side, out of the only or downstream last laminating gap 107; 107′ of the application stage 100; 100* and the entry into the calendering gap between the two calendering rollers 601; 602. In an advantageous refinement, a positively driven draw roller 502 and/or a measuring roller 409; 507 for ascertaining a web tension are also provided in a third substrate path segment, which is located between the exit location of the carrier substrate web 006, which has been provided with the dry film 003; 003′ at least on one side, out of the calendering gap and the winding location onto the product roll 501 in the product winder 500.

Preferably a web tension control device, which is not shown here, is provided, which on the input side are connected in each case to the or a measuring roller 208; 307; 409 provided in the first as well as the or a measuring roller provided in the second above-described substrate path segment and, on the output side are connected in each case to a drive controller, controlling the roller drives, of the or a draw roller 202; 308; 401 provided in the first as well as the or a draw roller provided in the second above-described substrate path segment, and which in particular comprises data processing means and/or electronic circuit means, which are equipped to build and/or to maintain a respective specified web tension and/or a web tension difference specified for the two substrate path segments by appropriate activation of the drive controller of the drive of one or more of the draw rollers 202; 308; 401 in each of the two substrate path segments. In a refinement, the web tension control device, on the input side, can additionally be connected in each case to the or a measuring roller 409; 507 provided in the third above-described substrate path segment and, on the output side, to a drive controller, controlling the drive of the relevant draw roller 502, of the or a draw roller 502 provided in the third above-described substrate path segment and, for example, can likewise be controlled by the same with respect to a specified web tension and/or a specified web tension difference relative to the upstream substrate path segment.

For an embodiment of the machine without a calendering unit downstream from the application stage 100; 100*, what was said above regarding the signal connections and regarding the installation of the web tension control device, is to be transferred in each case to a measuring and/or draw roller 208; 307; 409; 507; 202; 308; 401; 502 in the first substrate path segment between where the unwinding takes place and the point of the initial application by the application stage 100; 100*, and in a substrate path segment between where the only or last point of the dry film application by the application stage 100; 100* is left and where the winding in the reel winder 500 takes place.

As an alternative to the embodiment of the machine comprising a product receiving system 500 designed as a roll winder 500, in a particularly advantageous embodiment a cross-cutting device can be provided in the second substrate path 400 or at the input of the product receiving system 500, by which a product strand 002 produced in the machine can already be cross-cut into product sections 001. The product receiving system 500 is designed, for example, as a stack former, in particular as a multi-stack former consecutively forming multiple stacks.

In an above-described machine and/or device 100; 100*, for example, a web-format carrier substrate 006 is provided continuously, and preferably on both sides, with a dry film 003; 003′ having a smaller width in relation to the carrier substrate width, so that an uncoated edge of the carrier substrate remains on both sides.

Although the disclosure herein has been described in language specific to examples of structural features and/or methodological acts, it is to be understood that the subject matter defined in the appended claims is not necessarily limited to the specific features or acts described in the examples. Rather, the specific features and acts are disclosed merely as example forms of implementing the claims.

1-18. (canceled)

19. A coating device (100; 100*) for coating a carrier substrate (006) with a dry film (003; 003′), comprising at least one application unit (101) by which powdered material (004; 004′) can first be processed to a dry film (003) using a compression force, and thereafter this dry film (003; 003′) can be applied to a first side of the carrier substrate (006) as a powder composite film (003; 003′), the application unit (101; 101′) comprising a powder feed device (700; 700′) for feeding a powdered material (004; 004′) and a first roller (102; 102′) and a second roller (103; 103′) forming a first roller gap (104; 104′) with the first roller (102; 102′), a filling and/or supply chamber (126), into which powdered material (004; 004′) can be fed via a dispensing device (701) comprised by the powder feed device (700; 700′), being formed and/or provided in the region of the wedge-shaped space (108) formed above the gap (104; 104′) between the outer cylindrical surfaces of the first and second rollers (102; 102′; 103, 103′), the second roller (003; 003′) or a roller (003; 003′) which cooperates with the second roller (003; 003′) directly or indirectly via one or more further rollers and is effective as a laminating roller (003; 003′), in the nip between the outer cylindrical surface thereof and the outer cylindrical surface of a roller (106; 103′) effective as a counter-pressure roller (106; 103′), forming a second roller gap (107; 107′) through which the carrier substrate (006) can be guided and have the second dry film (003; 003′) formed via the first roller gap (104; 104′) applied thereto, characterized in that the dispensing device (701) comprises a receptacle (751) which is to be caused to vibrate by a vibratory drive (707) and has a bottom (753); that an opening (752) that is provided in the bottom (753) of the receptacle (751) is adjoined on the output side by a feed channel (756) via which the powdered material (004; 004′) can be dispensed from the receptacle (751) into the filling and/or supply chamber (126) located therebeneath; that a supply reservoir (703) comprising an outlet (757) is provided, via which the receptacle (751) to be caused to vibrate is or can be supplied with powdered material (004; 004′), the outlet (757) of the supply reservoir (703) being arranged spaced apart from the opening (752), viewed in the horizontal direction, and that the feed channel (756) on the output side is immersed with an outlet into the filling and/or supply chamber (126) formed over the roller gap (104; 104′) in the wedge-shaped space (108) between the outer cylindrical surfaces of the first roller (102; 102′) and the second roller (103; 103′).

20. The coating device according to claim 19, characterized in that a second application unit (101′; 101) is provided, into which powdered material (004′; 004) can be introduced via a further powder feed device (700′; 700) and processed therein to a second dry film (003′; 003), and thereafter this second dry film (003′; 003) can be applied to the other, second side of the carrier substrate (006); that the second application unit (101′; 101) comprises a second powder feed device (700′) for feeding a powdered material (004′) as well as a first roller (102′; 102) and a second roller (103′; 103) forming a first roller gap (104′; 104) with the first roller (102′; 102), a filling and/or supply chamber (126), into which powdered material (004; 004′) can be fed via a second dispensing device (701′) comprised by the powder feed device (700; 700′), being formed and/or provided in the region of the wedge-shaped space (108) formed above the gap (104; 104′) between the outer cylindrical surfaces of the first and second rollers (102; 102′; 103, 103′); that the second rollers (103; 103′) of the two application units (101; 101′) form the second roller gap (107; 107′) with one another, through which the carrier substrate (006) can be guided and have the second dry film (003; 003′) formed via the respective first gap (104; 104′) applied to both sides simultaneously, and that the second dispensing device (701′) comprises a receptacle (751) which is to be caused to vibrate by a vibratory drive (707) and has a bottom (753); that an opening (752) that is provided in the bottom (753) of the receptacle (751) is adjoined on the output side by a feed channel (756) via which the powdered material (004; 004′) can be dispensed from the receptacle (751) into the filling and/or supply chamber (126) located therebeneath; that a supply reservoir (703) comprising an outlet (757) is provided, via which the receptacle (751) of the second application unit (101′; 101) to be caused to vibrate is or can be supplied with powdered material (004; 004′), the outlet (757) of the supply reservoir (703) being arranged spaced apart from the opening (752), viewed in the horizontal direction, and that the feed channel (756) on the output side is immersed with an outlet into the filling and/or supply chamber (126) formed above the roller gap (104; 104′) in the wedge-shaped space (108) between the outer cylindrical surfaces of the first roller (102; 102′) and the second roller (103; 103′).

21. The coating device according to claim 19, characterized in that a fill level sensor (754) is provided above the bottom (753) comprising the opening (752).

22. The coating device according to claim 21, characterized in that a fill level in the receptacle (751) can be monitored by the fill level sensor (754).

23. The coating device according to claim 21, characterized in that the fill level sensor (754) is arranged over the opening (752) and/or that the fill level in the receptacle (751) and/or in or over the feed channel (756) can be monitored by way of the fill level sensor (754).

24. The coating device according to claim 21, characterized in that the fill level sensor (754) is arranged so as to be able to monitor a fill level in the receptacle (751) in a region that is spaced no more than 20 mm apart from the opening (752) and/or located upstream from the entry into the opening (752).

25. The coating device according to claim 21, characterized in that the fill level sensor (754) is designed as a sensor (754) by which the fill level can be monitored across a continuous range and/or controlled so as to set a certain level.

26. The coating device according to claim 21, characterized in that the fill level sensor (754) is designed as a sensor (754) operating according to a contactless measuring principle and/or based on sound waves and/or based on electromagnetic waves.

27. The coating device according to claim 19, characterized in that an opening (752) extending across the feed width and an adjoining feed channel (756) extending across the feed width are provided in the bottom (753), the feed width preferably corresponding with a maximum deviation of ±10% to a supply width of the filling and/or supply chamber (123) which is delimited on both sides in terms of the width and is formed over the roller gap (104; 104′).

28. The coating device according to claim 19, characterized in that a plurality of openings (752) and associated feed channels (756) are provided next to one another, viewed in the direction of the roller gap (104; 104′).

29. The coating device according to claim 19, characterized in that the receptacle (751) is designed in the form of a jogging vat (751) and/or with a circumferential wall.

30. The coating device according to claim 19, characterized in that the outlet (757) of the supply reservoir (703) is provided in or over the receptacle (751) that is to be caused to vibrate and at a height above the bottom (753) thereof.

31. The coating device according to claim 19, characterized in that a drive mechanism is provided, by which the distance between the bottom (753) of the jogging vat (751) and the supply reservoir (703) and/or the outlet (757) comprised by the supply reservoir (703) can be varied.

32. The coating device according to claim 19, characterized in that the receptacle (751) is designed as a jogging vat (751) comprising a circumferential wall, which has a height of more than 10 mm, and that the outlet (757) of the supply reservoir (703) is located at such a height above the bottom (753) that material (004; 004′) can exit into the jogging vat, the outlet (757), however, is located below the level of the maximum possible filling height determined by the wall of the jogging vat.
